(19) United States
(12) Patent Application Publication
(10) Pub. No.: US 2019/0163970 A1
(43) Pub. Date: May 30, 2019

(54) METHOD AND DEVICE FOR EXTRACTING CHART INFORMATION IN FILE

(71) Applicant: ABC FINTECH CO., LTD, Beijing (CN)

(72) Inventors: Zhou YU, Beijing (CN); Yongzhi Yang, Beijing (CN); Manye Yang, Beijing (CN)

(21) Appl. No.: 15/955,616

(22) Filed: Apr. 17, 2018

(30) Foreign Application Priority Data
Nov. 29, 2017 (CN) 201711223065.2

(51) Int. Cl. G06K 9/00

(52) U.S. Cl. CPC G06K 9/00456; G06K 9/00463; G06K 9/00449

(57) ABSTRACT

An embodiment of the present application provides a method for extracting chart information in a file performed by an electronic device. The method comprises: inputting a file which includes a to-be-identified page into the electronic device; parsing by the electronic device underlying data stored in the to-be-identified page, combining the underlying data into a data block according to a behavior identifier in the underlying data; extracting by the electronic device a graphic object and a word object from the data block respectively, obtaining location information of the word object and of the graphic object in the to-be-identified page; identifying a chart area in the to-be-identified page according to the graphic object and the word object; and performing on the electronic device data fusion on the word object and the graphic object in the chart area to obtain chart information contained in the chart area.

### CROSS-REFERENCE TO RELATED APPLICATION

This application claims the benefit of Chinese Patent Application No. 201711223065.2, filed Nov. 29, 2017 with State Intellectual Property Office, the People's Republic of China, the entire content of which is incorporated by reference herein.

### TECHNICAL FIELD

The present application relates to the field of data processing technology, and in particular to a method and a device for extracting chart information in a file.

### BACKGROUND

Portable File Format (PDF) is an electronic file format that is widely used in all major operating systems. Many e-books, a financial statement of a financial company, a scientific literature, and so on all use a PDF file form. For example, there are a large number of charts in a PDF file in a financial study report, the information and data contained in these charts are all very important. However, since under the format of the PDF file per se, the chart is not structured, the stored chart data cannot be directly used by other computer programs, and the user cannot perform search or analysis and other processing processes on the chart in the PDF file.

In the prior art, when a PDF file is converted into a file in another format, and when an image stored therein is extracted, either the entire page is directly extracted from the PDF file as one image or all image elements are extracted from the PDF file. However, an image extracted by using the former method cannot be edited, and by using the latter method, only the image elements can be edited but the entire image cannot be edited after a large number of the image elements are extracted.

### SUMMARY

To solve the above technical problems, an embodiment of the present application provides a method and a device for extracting chart information in a file, a computer-readable storage medium and an electronic apparatus.

On one hand, an embodiment of the present application provides a method for extracting chart information in a file on an electronic device, comprising:

inputting a file which includes a to-be-identified page into the electronic device;

parsing, by the electronic device, an underlying data stored in the to-be-identified page, and combining the underlying data into a data block according to a behavior identifier in the underlying data;

extracting, by the electronic device, a graphic object and a word object from the data block respectively, and obtaining location information of the word object and the graphic object in the to-be-identified page;

identifying a chart area in the to-be-identified page according to the graphic object and the word object;

performing, on the electronic device, data fusion on the word object and the graphic object in the chart area to obtain the chart information contained in the chart area; wherein the graphic information comprising one or more of a title, a legend, a scale, and a scale attribute.

On the other hand, an embodiment of the present application provides a device for extracting chart information in a file on an electronic device, comprising:

a parsing unit configured to parse an underlying data stored in a to-be-identified page and combine the underlying data into a data block according to a behavior identifier in the underlying data;

a graph-and-word extraction unit configured to extract a graphic object and a word object respectively from the data block and obtain location information of the word object and the graphic object in the to-be-identified page;

a chart area identification unit configured to identify a chart area in the to-be-identified page according to the graphic object and the word object;

an information fusion unit configured to perform data fusion on the word object and the graphic object in the chart area to obtain chart information contained in the chart area; wherein the chart information comprising one or more of a title, a legend, a scale, and a scale attribute.

In one aspect, an embodiment of the present application further provides a computer-readable storage medium comprising a computer readable instruction, the computer-readable instruction, when executed, makes a processor perform an operation in any one of the above methods for extracting the chart information in the file.

In another aspect, an embodiment of the present application further provides an electronic apparatus, comprising a memory for storing program instructions and a processor being connected with the memory, for executing the program instructions in the memory, and extracting the chart information in the file according to any one of the above methods.

With the embodiment of the present application, a chart in a file page can be identified, and a data in the chart can be extracted, thereby enabling the chart or image in the file page to be conveniently edited. The deficiency and defect in the prior arts is easily overcome. The embodiment of the present application obtains the chart information stored in the file comprising a word, location information of the word in the file page, various graphic elements and location information of the graphic elements in the file page by parsing the contents of the file pages in various formats, finds a chart area in the file page by combining these information, further analyzes this area to obtain a chart element such as a title, a legend, a coordinate axis, a coordinate axis scale word, a broken line, and a column and so on, redraws the chart in the file with these information, and can perform search or analysis and other processing processes on these elements.

### BRIEF DESCRIPTION OF THE DRAWINGS

To describe the technical solution in the embodiments of the present application or in the prior arts more clearly, the following briefly introduces the accompanying drawings required for describing the embodiments or the prior arts. Apparently, the accompanying drawings in the following description show merely some embodiments of the present application, for those skilled in the art, other drawings may be obtained based on these drawings without creative efforts.

FIG. 1 is a flow chart of a method for extracting chart information in a file according to some embodiments of the present application;

FIG. 2 is an example of a pie chart according to some embodiments of the present application;

FIG. 3 is a filled area object with a white background in the pie chart shown in FIG. 2;

FIG. 4 is a filled area object of other colors or picture backgrounds in the pie chart shown in FIG. 2;

FIG. 5 is a first graphic object in the pie chart shown in FIG. 2;

FIG. 6 is a second graphic object in the pie chart shown in FIG. 2;

FIG. 7 is a chart area obtained by combining a first graphic object and a second graphic object that are adjacent in position;

FIG. 8 is a third graphic object in the pie chart of FIG. 2;

FIG. 9 is a new chart area obtained by combining the third graphic object in FIG. 8 with the chart area shown in FIG. 7;

FIG. 10 is a first word object in FIG. 2;

FIG. 11 is a new chart area obtained by combining the first word object in FIG. 10 and the chart area shown in FIG. 9;

FIG. 12 is a chart area obtained after combining word information in FIG. 2 one after another;

FIG. 13 is a new chart area obtained after combining one legend into the chart area shown in FIG. 12;

FIG. 14 is a new chart area obtained after all legends are combined into the chart area shown in FIG. 12;

FIG. 15 is a pie chart redrawn based on the chart information extracted from FIG. 2;

FIG. 16 is a flow chart of a method for identifying a chart area in a to-be-identified page;

FIG. 17 is an example of a combined view according to some embodiments of the present application;

FIG. 18, FIG. 19 and FIG. 20 are data blocks comprising a word object of a part of a combined view shown in FIG. 17;

FIG. 21 is an effect view after a word object is combined based on semantic information and location information;

FIG. 22 is an example of a chart with an inclined scale according to some embodiments of the present application;

FIG. 23, FIG. 24 and FIG. 25 are data blocks comprising an inclined scale of a chart portion shown in FIG. 22;

FIG. 26 is an area view according to some embodiments of the present application;

FIG. 27 is a histogram according to some embodiments of the present application;

FIG. 28 is a broken line view according to some embodiments of the present application;

FIG. 29 is an effect view by matching a sector object and a legend according to a color according to some embodiments of the present application;

FIG. 30 is a pie chart according to some embodiments of the present application, in which a part of the sectors has no proportion information;

FIG. 31 is a parsing result obtained from parsing the pie chart shown in FIG. 29 by using a method according to some embodiments of the present application;

FIG. 32 is a view of a flow chart of a method for obtaining scale information in a chart area according to some embodiments of the present application;

FIG. 33 is an example of dividing a chart into a left subarea and a right subarea according to a method according to some embodiments of the present application;

FIG. 34 is an example of dividing the chart in FIG. 33 into an upper subarea and a lower subarea according to a method according to some embodiments of the present application;

FIG. 35 shows a spatial regularity of the scales of each side in FIG. 33;

FIG. 36 is final scale information of FIG. 33 obtained by using a method according to some embodiments of the present application;

FIG. 37 is an example of a broken line chart with the number of vertexes greater than the number of X-axis scales according to some embodiments of the present application;

FIG. 38 is an example of a combined view with the number of the columnar rectangles greater than the number of X-axis scales according to some embodiments of the present application;

FIG. 39 is an example of a horizontal histogram according to some embodiments of the present application;

FIG. 40 is an example of a combined view according to some embodiments of the present application;

FIG. 41 is a structural view of a device for extracting chart information in a file according to some embodiments of the present application; and

FIG. 42 is a structural view of an electronic apparatus according to some embodiments of the present application.

### DETAILED DESCRIPTION OF THE EMBODIMENTS

The technical solution in the embodiments of the present application will be clearly and completely described below with reference to the accompanying drawings in the embodiments of the present application, obviously, the described embodiments describe only a part but not all of the embodiments of the present application. All other embodiments obtained by those skilled in the art without any inventive work are within the scope of the present application, based on the embodiments of the present application.

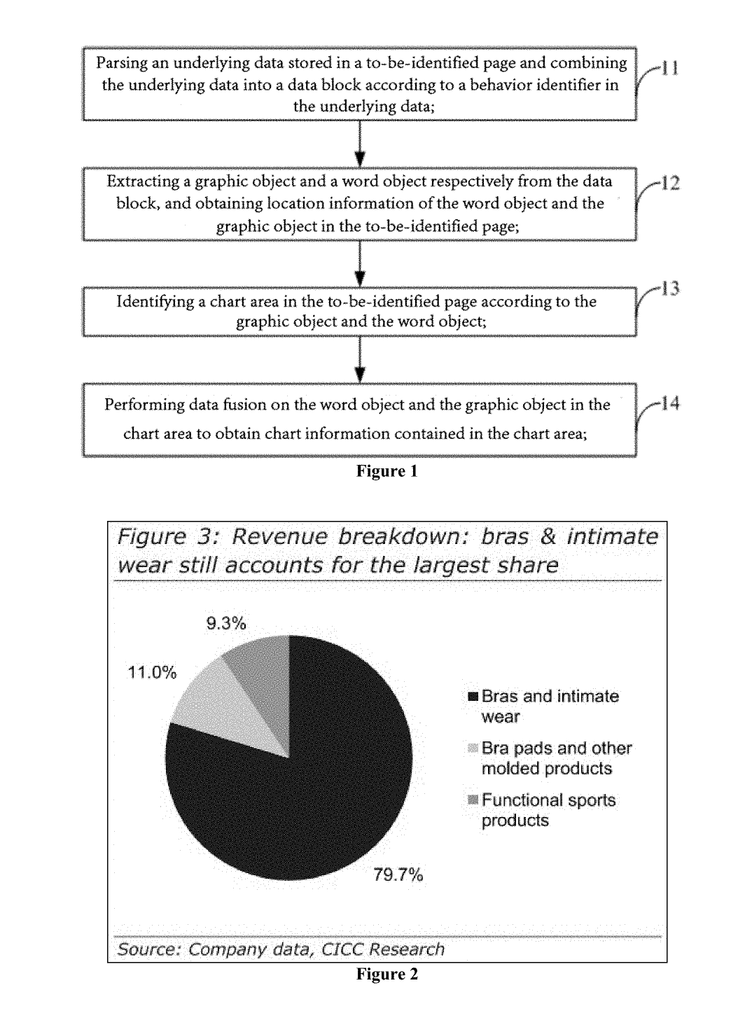

FIG. 1 is a view of a flow chart of a method for extracting chart information in a file according to some embodiments of the present application. It should be noted that a “file” mentioned in the embodiment of the present application comprises, but is not limited to, a file of PDF format and may also be other files that contain vector type data.

As shown in FIG. 1, the method mainly comprises the following steps:

Step 11: parsing underlying data stored in a to-be-identified page, combining the underlying data into a data block according to a behavior identifier in the underlying data.

The underlying data, including various types of numerical values, words, statuses and behavioral identifiers, should not be directly analyzed, therefore, the underlying data needs to be effectively combined into a complete data block object (Content Group) having an actual meaning or capable of being executable, before being analyzed. When combined, the underlying data may be combined according to a behavioral identifier in the underlying data. Usually, after the underlying data is parsed and obtained, it is first checked whether more representative behavior identifiers such as f, f*, b, B*, BT, ET, q, Q, and so on are provided, a data block between an action identifier and f* usually represents the underlying data obtained after a graphic object in a chart is parsed; the data block between BT and ET usually represents the underlying data obtained by parsing the words in the chart. It should be noted that the foregoing examples are merely a part of the embodiments of the present application, and are not intended to limit the present application.

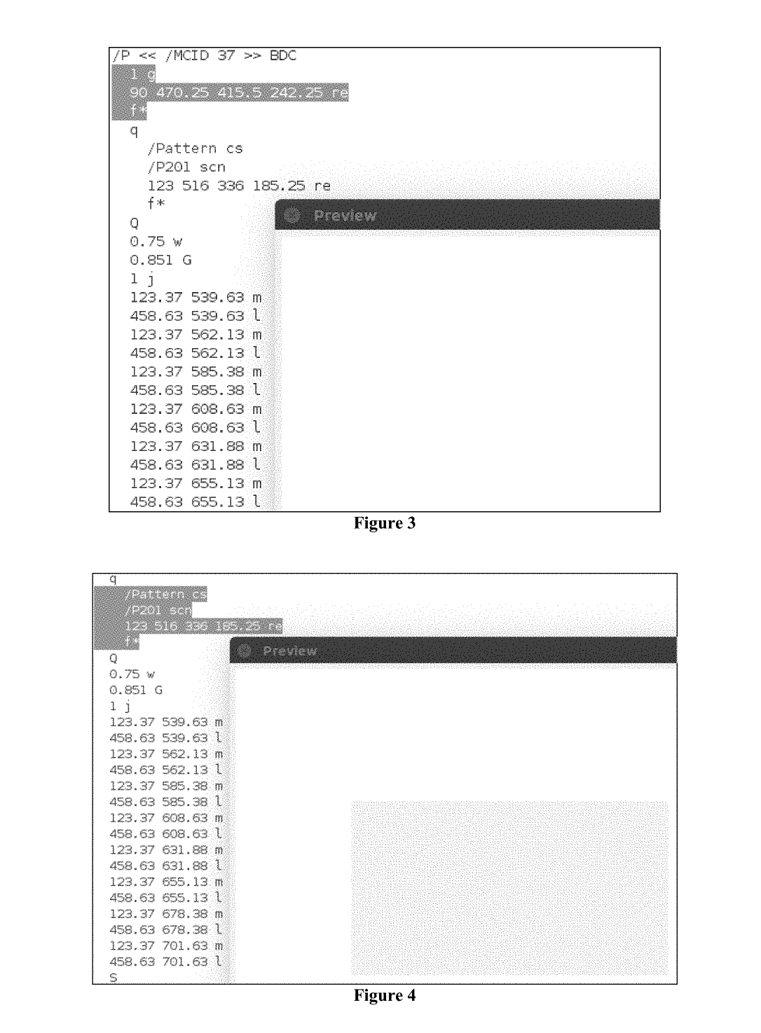

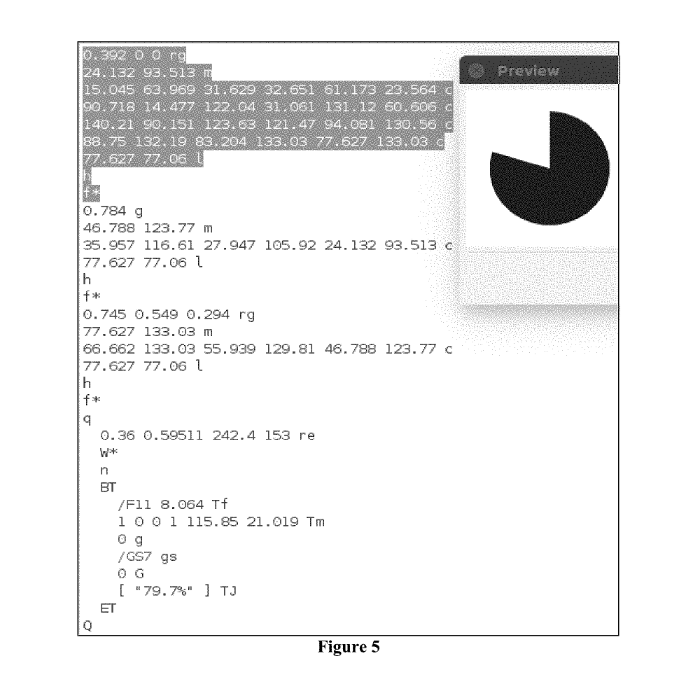

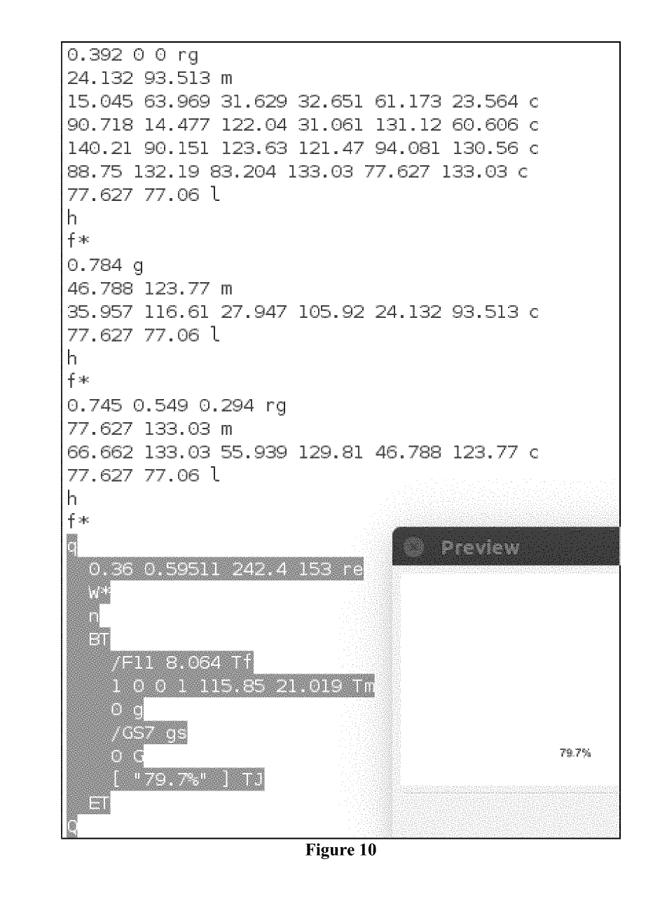

FIG. 2 shows a pie chart in a to-be-identified page of a file according to some embodiments of the present application, after the underlying data stored on the page is identified, the underlying data is parsed. As shown in FIG. 3 to FIG. 14, data shown on the left side of the figure is a part of the underlying data obtained by parsing the to-be-identified page, including various types of the numerical values, word statuses and the behavior identifiers, a preview box on the right side of the figure shows what the selected data block on the left side of the figure represents, the data block contains the behavior identifier, numerical value, and so on. Wherein, the underlying data selected in the left area of FIG. 3 is ended with f*, the underlying data in this section represents a filled area object with a white background in the pie chart shown in FIG. 2; the underlying data selected in the left area of FIG. 4 is ended with f*, the underlying data represents the filled area object where the pie chart shown in FIG. 2 has a background in a different color or a picture; the underlying data selected in the left areas of FIGS. 5-6 and FIG. 8 are all ended with f*, the underlying data in these three sections represent three sector objects in the pie chart shown in FIG. 2, respectively; the underlying data selected in the left area of FIG. 10 starts with BT and is ended with ET, the underlying data in this section represents a word object “79.7%” in the pie chart shown in FIG. 2.

Step 12: extracting the graphic object and the word object from the data block respectively, and obtaining location information of the word object and the graphic object in the to-be-identified page.

The data block obtained in Step 11 usually contains the word object (for example, the content shown in FIG. 10) and the graphic object (for example, the contents shown in FIGS. 5-6 and 8). In order to further parse the to-be-identified page, it is needed to extract from the data block the graphic object and the word object and the location information of the graphic object and the word object in the to-be-identified page, the location information is reflected in the data block corresponding to each word object and each graphic object.

For example, the above graphic element may be a point, a line, a rectangular area, a sector area, or the like. If a coordinate system is drawn on the to-be-identified page of the file, after the underlying data obtained by parsing the page is combined, the underlying data usually contains coordinate information, which may be a coordinate of the certain point, coordinates of two ends of a certain straight line or coordinates of a filled area.

Step 13: identifying a chart area in the to-be-identified page according to the graphic object and the word object.

In order to extract the chart information in the file more quickly and accurately, in the embodiment of the present application, the chart area in the page is usually identified first, and then the graphic object and the word object in the chart area are analyzed to obtain the corresponding chart information.

Step 14: performing data fusion on the word object and the graphic object in the chart area to obtain the chart information contained in the chart area; wherein the chart information comprises at least one of a title, a legend, a scale, and a scale attribute.

In this embodiment of the present application, the chart information contained in the page is extracted by parsing the to-be-identified page of the file, which enables a user to conveniently search or edit the extracted chart information, and also view or derive the chart information to analyze the chart.

In one embodiment, the following two methods are usually used to identify a valid chart area in a file page: 1) directly finding a reasonable and effective rectangle filled area as a candidate graph area, for example, a filled area object shown in a preview box on the left in FIGS. 3 and 4 is used as a candidate chart area; 2) randomly selecting a certain graphic object, staring from this graphic object, gradually combining with the other adjacent graphic objects and word objects in the proximity, and expanding the scope of the area to some degree, for example, the area may be outwardly expanded according to a preset ratio, and it is determined whether the current candidate chart area achieved through combination constitutes a valid chart area.

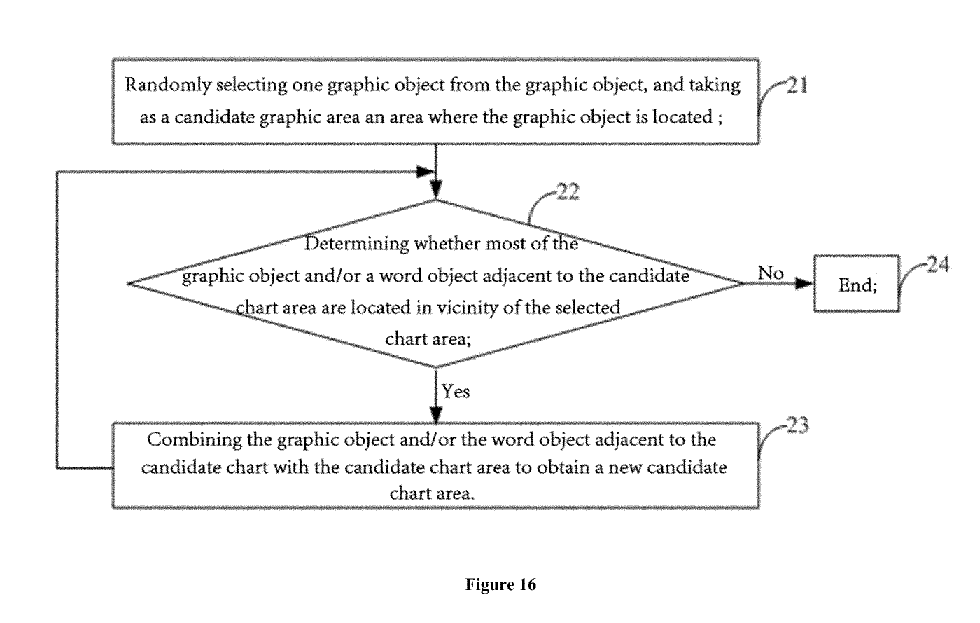

The specific steps of an embodiment of the method step 2) are described by the embodiments of the present application with reference to the accompanying drawings in the description. For details, please refer to FIG. 16. FIG. 16 is a view of a flow chart of a method for identifying the chart area in the to-be-identified page. As shown in FIG. 16, the method mainly comprises the following steps:

In Step 21, randomly selecting one graphic object from the graphic objects obtained in Step 12, and taking the area where the graphic object is located as the chart area.

In Step 22, determining whether most of the graphic objects and/or the word objects adjacent to the candidate graphic area are located inside the candidate graphic area.

When it's implemented specifically, it is determined whether the area of the parts of the graphic objects or the word objects adjacent to the candidate chart area inside the candidate chart area exceed a preset ratio compared to the total area of the graphic objects or the word objects. If the preset ratio is exceeded, the graphic objects or the word objects can be considered as being located inside the candidate chart area. The preset ratio may be set by the user, for example, it may take any value between 60% and 100%, which is not limited in this embodiment of the present application. If most of the graphic objects and/or the word objects adjacent to the candidate chart area are located inside the candidate chart area, the processing of step 23 is performed, otherwise, it may be inferred that there is no graphic object or word object adjacent to the currently selected graphic object is present around the currently selected graphic object, and the candidate chart area can be used as the chart area, and the determination can be ended (Step 24).

In Step 23, combining the graphic objects and/or the word objects adjacent to the candidate chart area with the candidate chart area to obtain a new candidate chart area.

Steps 22 and 23 are repeated until most of the graphic objects and/or the word objects adjacent to the newest candidate chart area are located outside the newest candidate chart area, and the newest candidate chart area is taken as the chart area of the to-be-identified page.

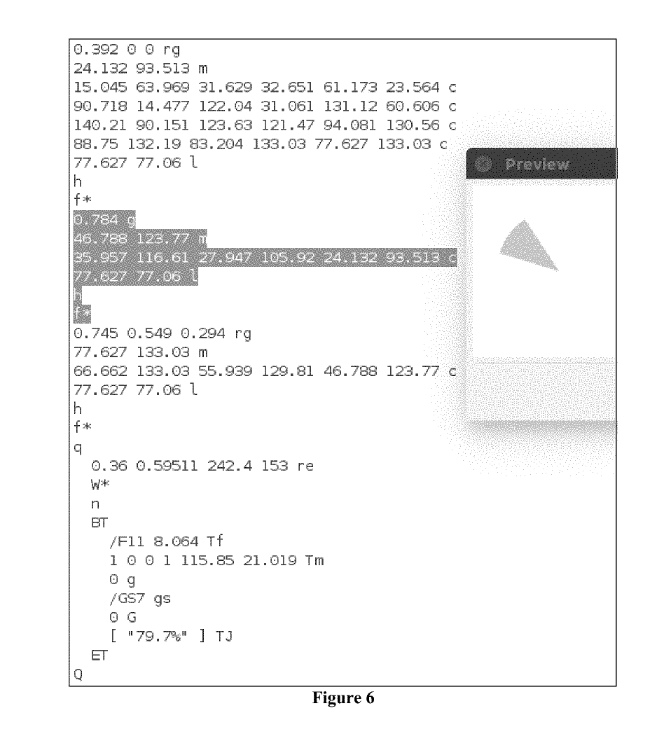

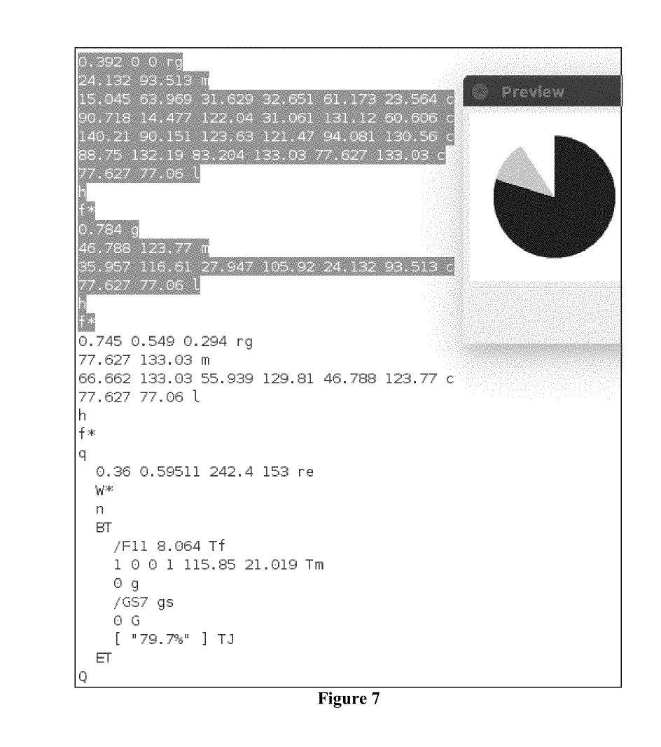

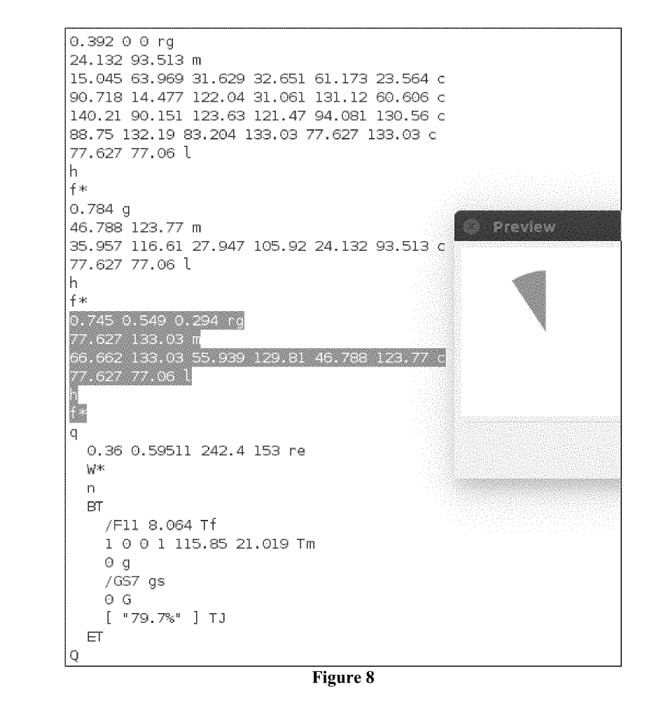

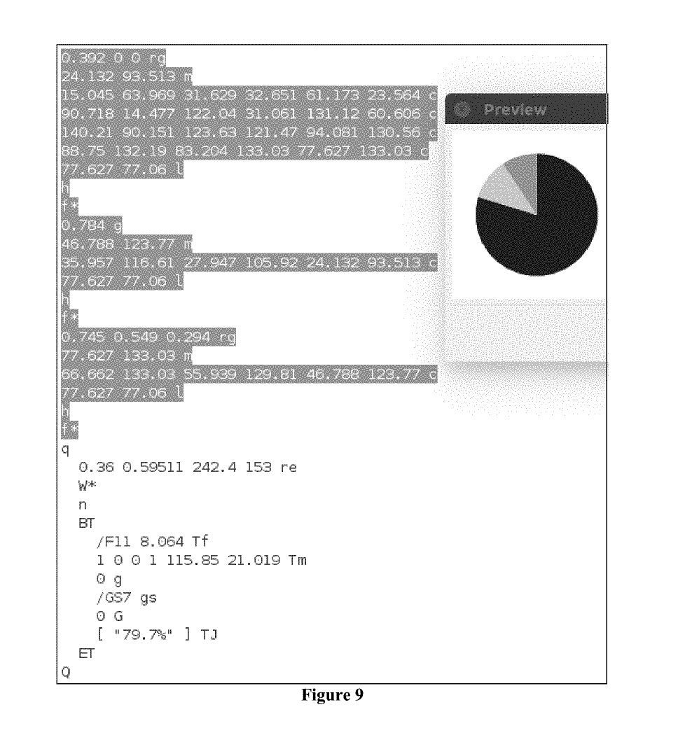

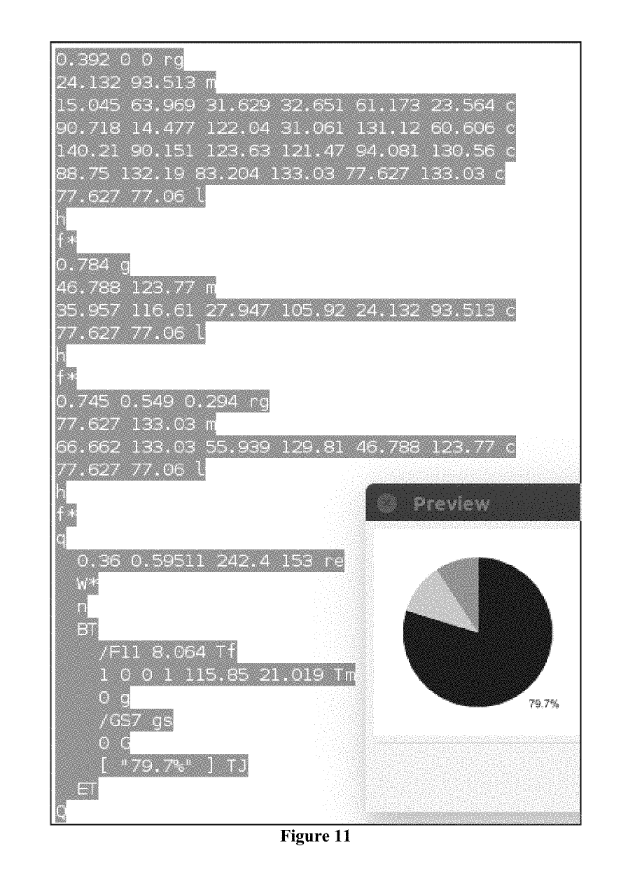

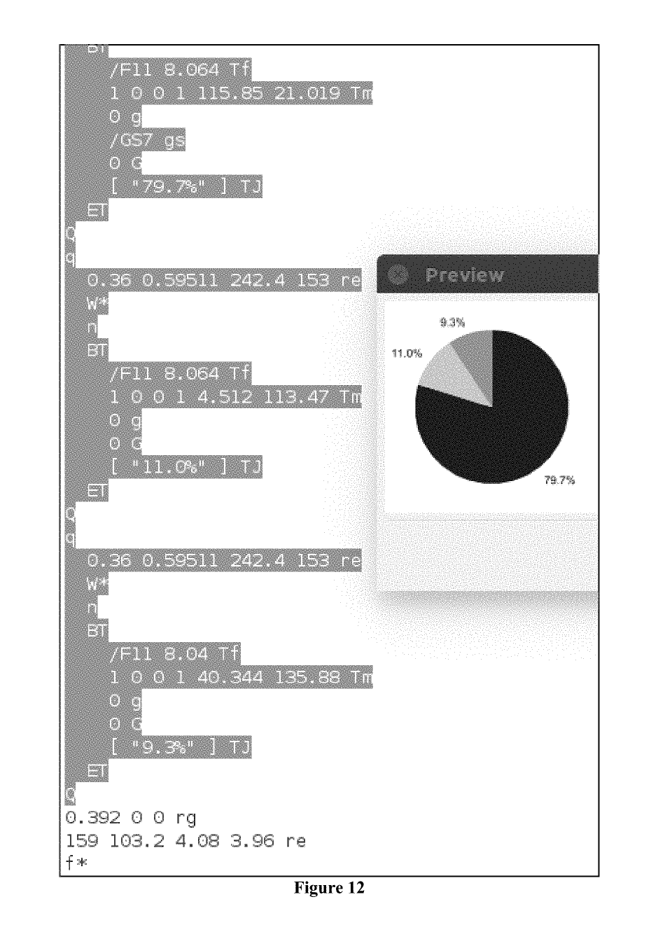

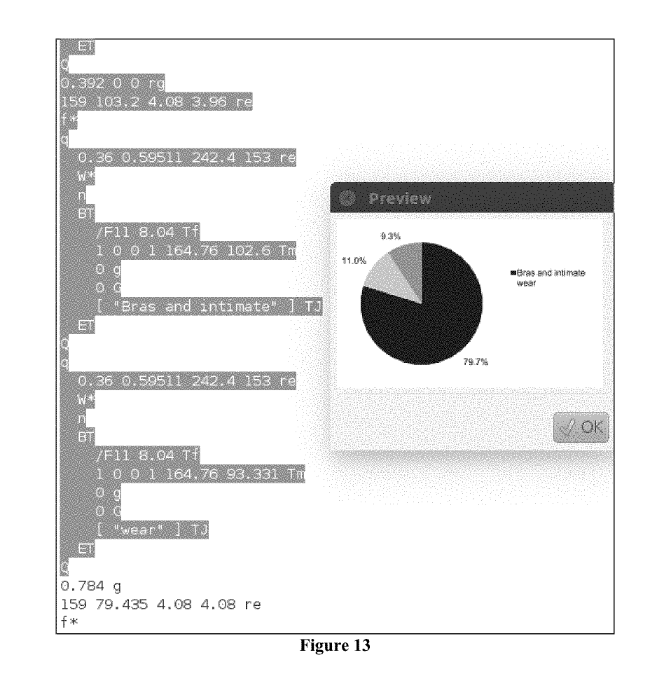

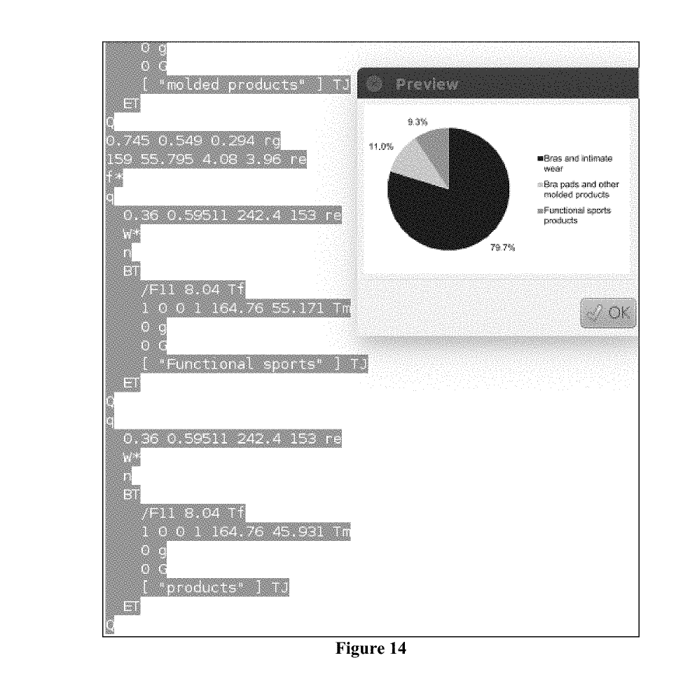

The above steps will be described in conjunction with the accompanying drawings. All data block objects (including the graphic objects and the word objects) in the current page are processed sequentially. If a currently selected graphic object is a graphic object shown in the preview box on the right of FIG. 5, the area in which the currently selected graphic object is located is used as the candidate graphic area. The graphic object shown in FIG. 5 is the first graphic object, and the next graphic object is then processed (see FIG. 6), most of the area of the graphic objects shown in FIG. 6 is located inside the area where the graphic object shown in FIG. 5 is located, and combined together, and the effect of combination is as shown in FIG. 7. Other graphic objects are processed by the same method in succession, as shown in FIG. 8 and FIG. 9, after the chart area shown in FIG. 9 is obtained, a certain range is expanded outwardly to serve as the new candidate chart area. Next, the word object is processed (see FIG. 10). Most of the area of the word object “79.7%” is located inside the new candidate chart area and is combined together, and the effect of combination is shown in FIG. 11. The candidate chart area is gradually expanded based on the same method one after another, and the other word objects in FIG. 2 may be combined, the new candidate chart area is shown in FIG. 12 after part of the word objects are combined. Next, an outward expansion is continued to obtain the candidate chart area, the small-size graphic object and the small-size word object (the two may form the legend) are processed, of which an effect is shown in FIG. 13, for example, most of the area in which the graphic object and the word object are located falls within the candidate chart area, similarly, the graphic object and the word object are combined into the candidate chart area to obtain the chart area as shown in FIG. 14.

If most of the area of the graphic object appears outside the chart area or does not belong to the current chart content, the validity of the chart area is determined, if the chart area is valid, the chart area is saved, and then all of the graphic objects and word objects are processed based on the described above method until all the data block objects in the to-be-identified page are processed.

In an embodiment, each time when a candidate chart area is obtained, it is further necessary to determine whether the size of the chart area is too large or too small, only when the size of the candidate chart area is neither too large nor too small, the candidate chart area may be regarded as the valid chart area, the valid chart area may be further expanded, or the chart area may be used as the final chart area of the to-be-identified page.

When it is determined whether the size of the candidate chart area is too large, it is usually determined whether the width of the candidate chart area is greater than 80% of the width of the to-be identified page and whether the height of the candidate chart area is greater than 85% of the height of the to-be-identified page, if both of the conditions are met at the same time, it is indicated that the size of the candidate chart area is too large.

when it is determined whether the size of the candidate chart area is too small, it is usually determined whether the width of the candidate chart area is less than 10% of the width of the to-be-identified page and whether the height of the candidate chart area is less than 7% of the height of the to-be-identified page, if both of the conditions are met at the same time, it is indicated that the size of the candidate chart area is too small.

In addition, when an aspect ratio of the candidate chart area is more than 0.2 and less than 5, it can be considered that the aspect ratio of the candidate chart area is moderate, if the aspect ratio of the chart area is not within this range, it is indicated that the identified chart area may not be a valid chart area, and a reminder message can be generated to remind the user.

In order to further know the type of the chart so that the chart information can be parsed out later, the embodiments of the present application may further analyze the graphic objects and the word objects. The graphic object is usually composed of basic filled elements and contour elements. When the graphic object is parsed, the filled elements and the contour elements are needed to be extracted from the graphic object to parse out colors and paths of the filled elements and the contour elements. The type of each graphic object is determined based on the color and the path, and if the chart area has been already defined, the type of chart may be determined based on the type of graphic object contained in the chart area.

For example, if the filled elements of the graphic object contain one or more rectangle objects, the filled elements are construction elements of a columnar graphic object; if the filled elements contain a large number of enclosed areas consisting of pairs of points which have the same X coordinate values but different Y coordinate values, the filled elements are the filled area of an area graphic object; if the filled elements constitute an approximate sector object consisting of several small arc sections consisting of three points and each arc section is approximately equidistant from a center point thereof, the filled elements are construction elements of a sector graphic object.

For another example, if the contour elements of the graphic object are dotted line objects, the graphic object may be a broken line object which has a corresponding legend, or an auxiliary line; if the contour element is a horizontal or vertical straight line and the length thereof or the height thereof is greater than 30% of the width of the chart area, the contour element may be the contour of a graph object of a coordinate axis; if the contour element is a horizontal or vertical short segment with a smaller size, the contour element may be a scale line of the coordinate axis or an indicating line of the legend (i.e., an icon of the legend); if the contour element comprises a plurality of horizontal or vertical straight lines, and these straight lines are spatially arranged equidistantly, the contour element may be a structural element of an auxiliary grid line; if the contour element consists of a number of segments that are indefinite in number and of which paths are not closed, the contour element may be a construction element of the graphic object of a broken line.

When special word information is present in the chart, although it visually displays as a regular word, the data block obtained after the page is identified is actually a graphic object of a similar word pattern. When this type of graphic object is identified, when path information of the filled elements or the contour elements presents the word pattern, the graphic object is saved as a bitmap object, and then a word in the bitmap object is identified by an OCR model.

The type of the graphic object determined by the above method mainly comprises at least one of the sector object, a broken line object, an area object, a columnar object, the coordinate axis, a coordinate axis scale line, the auxiliary line, the icon and the bitmap object. If the graphic object is a short rectangular box or a horizontal line segment and the adjacent data block thereof is the word, it is likely that the graphic object is an indicating line (i.e. the icon) of the legend. If the aspect ratio of the area of the graphic object is greater than 0.3 and less than 3, the graphic object is likely to be the bitmap object, and the graphic object may be first classified as the bitmap object, the graphic object is then identified by trying to use the OCR model to see if the word is identified, if the word may not be identified, it is indicated that the graphic object should actually be the graphic object.

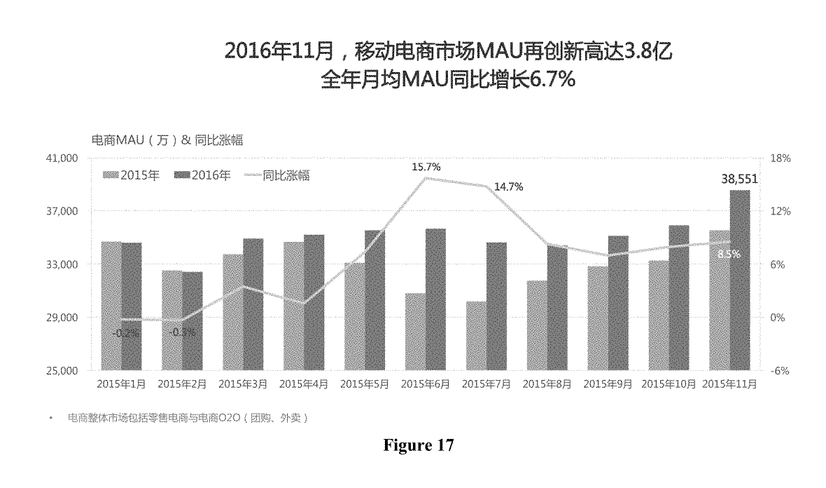

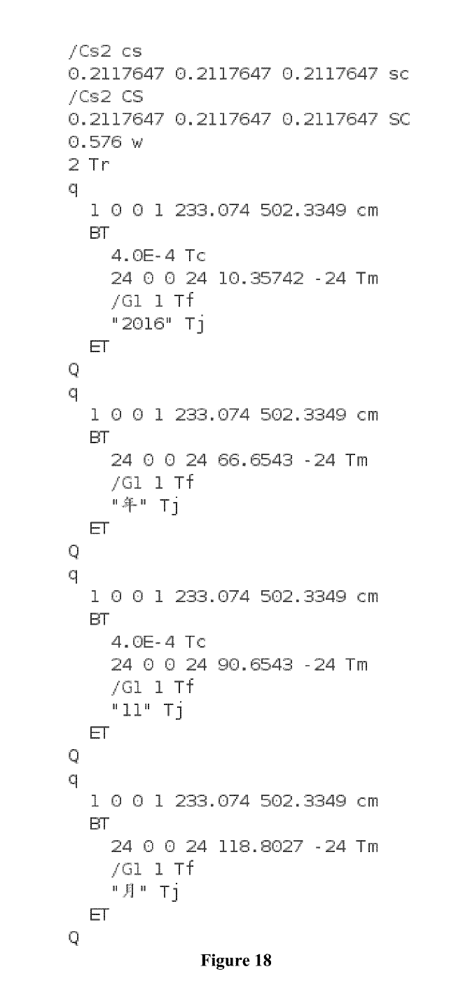

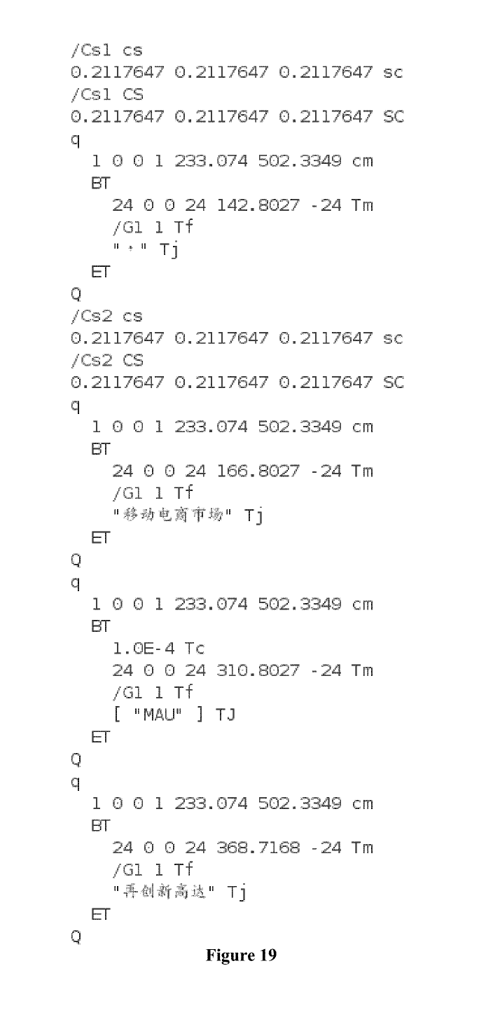

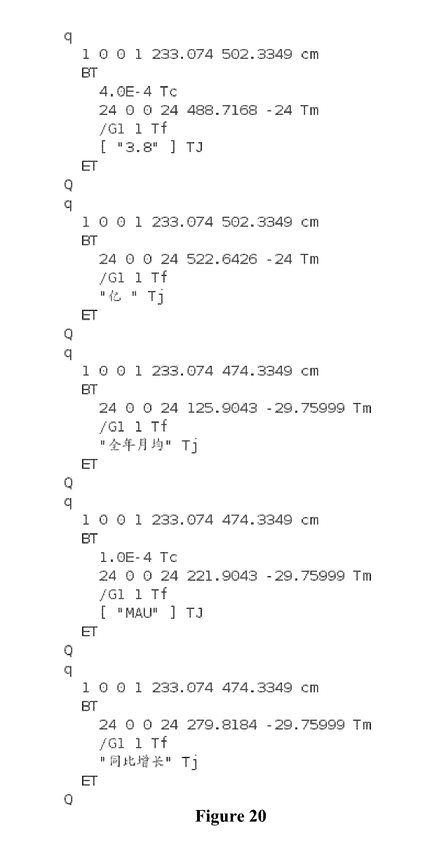

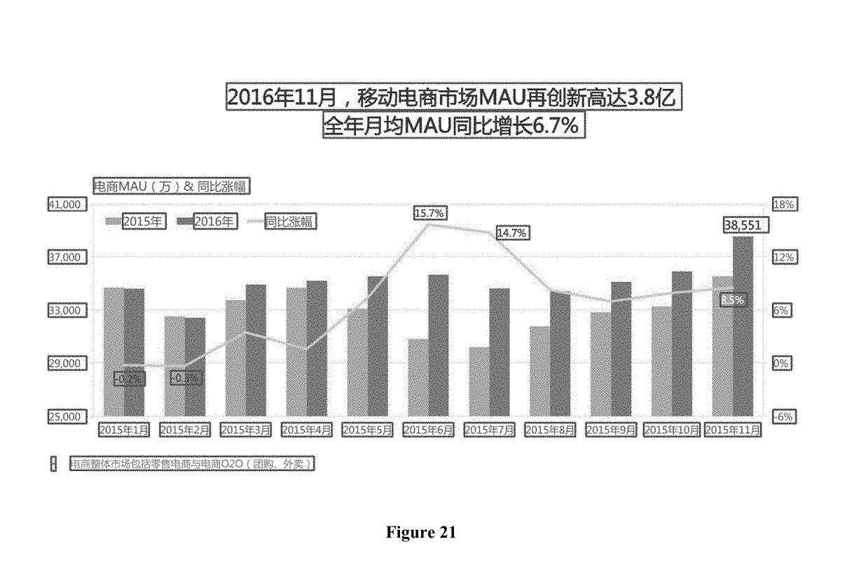

Next, according to location information and semantic information of the word object, the semantically related word objects in close proximity are reorganized into a valid text block. The semantic information comprises but is not limited to at least one of a character type, a font type, a font size, a font color and a font direction. FIG. 17 is an example of a combined view according to some embodiments of the present application. After the word is divided into a single character object according to dimensions such as the character type, a font, the color, a size, a position and a direction, the data blocks shown in FIG. 18, FIG. 19 and Figure may be obtained, these three figures only contain part of the word objects in the combined view shown in FIG. 17, which is only used for describing the embodiments of the present application, but not for limitation thereto. After the other data blocks obtained after FIGS. 18-20 and FIG. 17 are identified are spatially and semantically combined, the data blocks can be restructured into the valid text blocks as shown in FIG. 21.

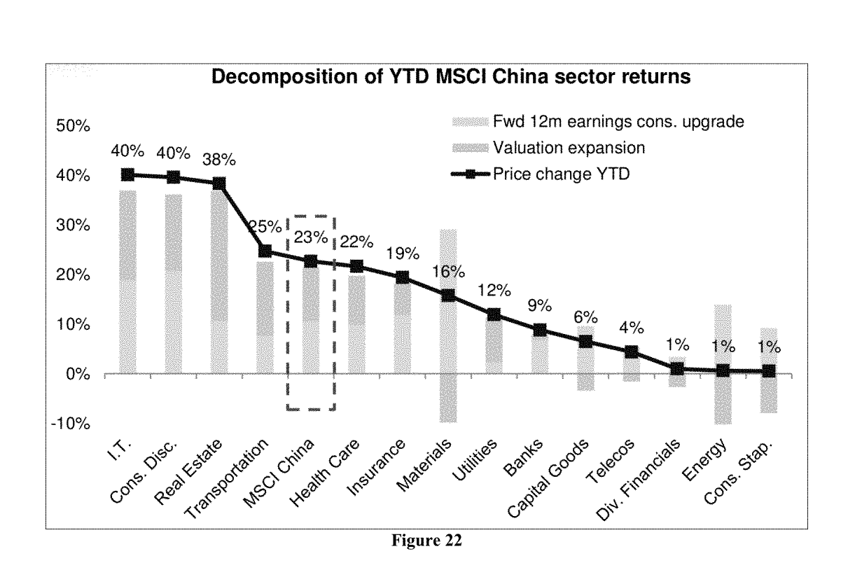

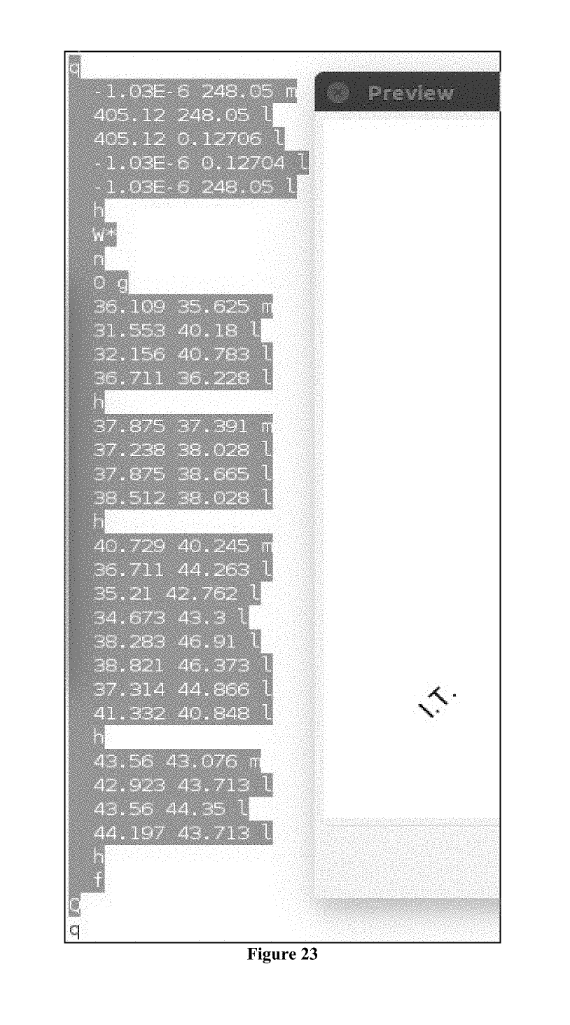

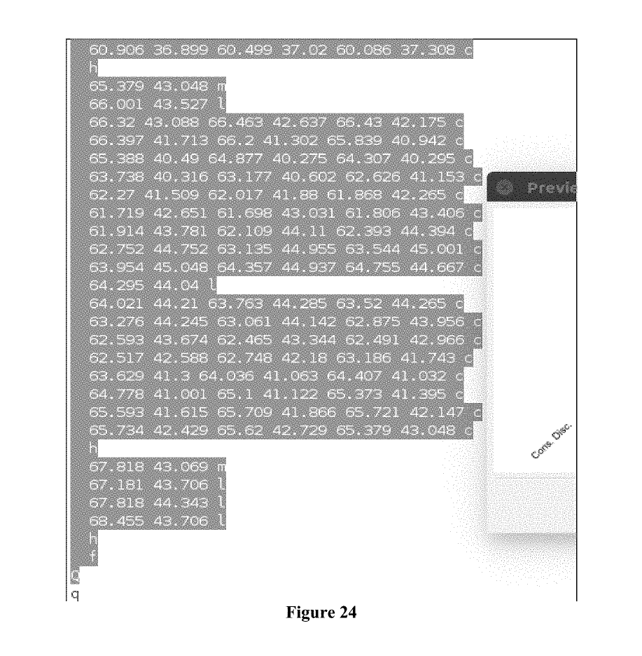

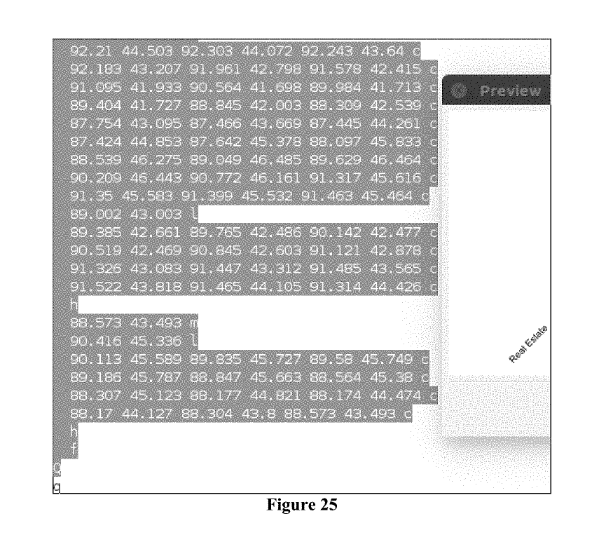

FIG. 22 is an example of a chart with inclined scales according to some embodiments of the present application, the scales on the lower side of the chart are scale information on a direction of 45 degree angle counter clockwise. The part of the data blocks obtained after the identification of FIG. 22 are respectively shown in FIG. 23, FIG. 24 and FIG. 25. The data block in FIG. 23 represents the graphic object that contains an “IT.” word pattern, the data block in FIG. 24 represents the graphic object that contains a “Cons. DisC.” word pattern, the data block in FIG. 25 represents the graphic object that contains a “Real Estate” word pattern. After the above graphic object is obtained, the graphic object is saved as the bitmap object by rotating the graphic object to an approximate horizontal direction. The trained OCR model is then used to identify the bitmap object. The identified results are I.T., Cons. DisC., Real Estate, and so on. Finally, all restructured valid text blocks are stored.

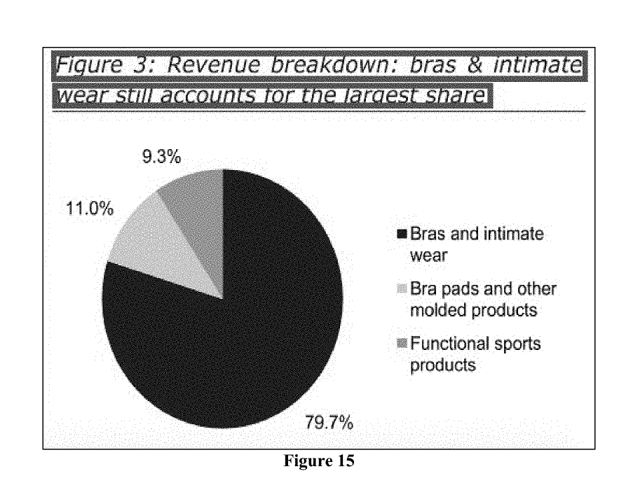

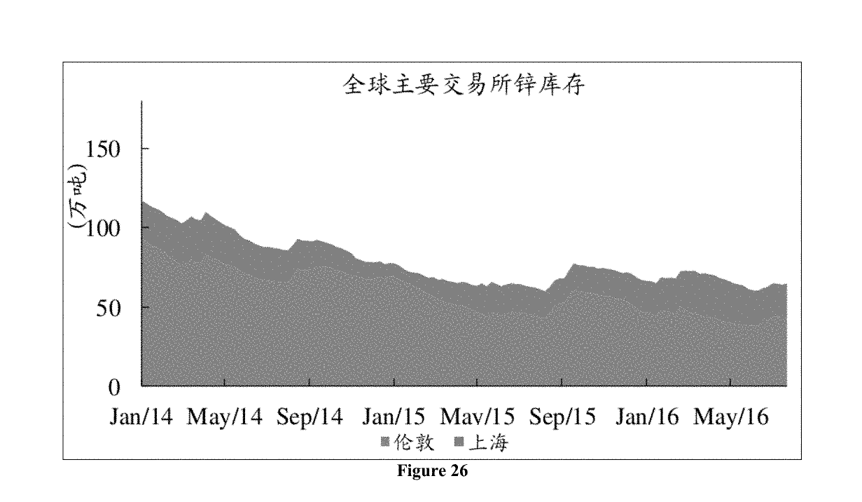

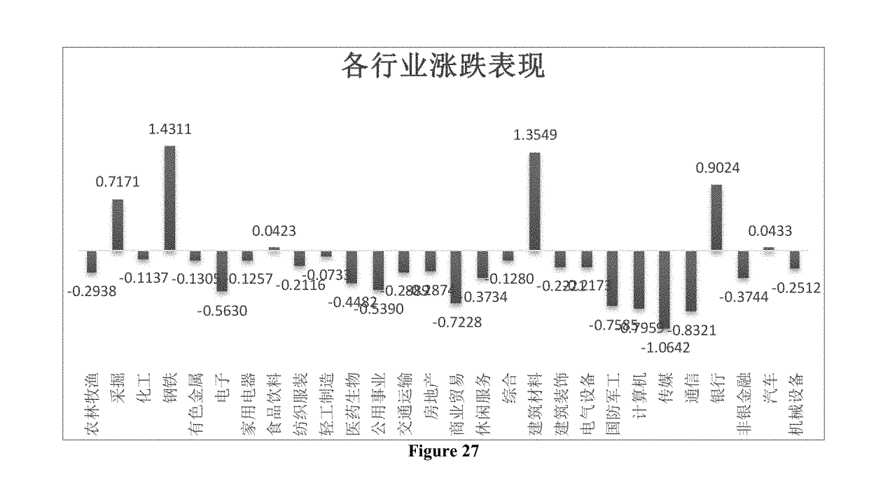

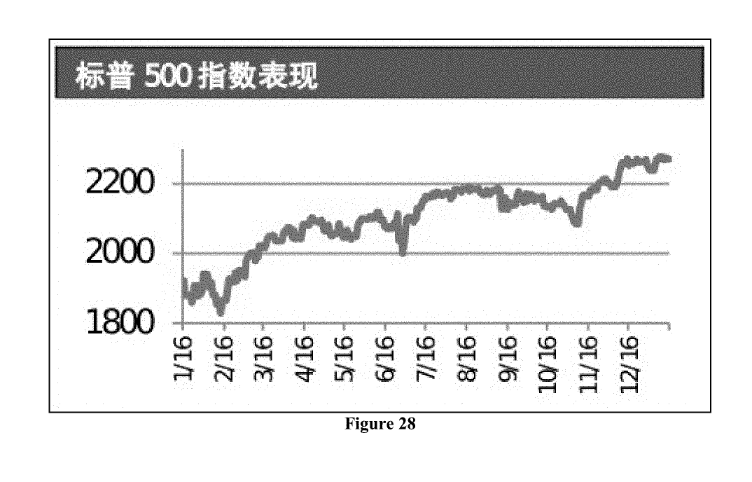

In one embodiment, when a chart title is parsed by using Step 14, the valid text blocks in the chart area are usually traversed. In combination with a preset semantic library, it is determined whether a valid text block is a title of the chart. For example, the first word of each valid text block is checked to determine whether it comprises one of the words such as “Figure”, “Figure”, “figure”, “Exhibit”, “exhibit”, “Chart”, and “chart”. If a certain valid text block contains a “figure” word, the valid text block may be set as the candidate title. If none of the valid text blocks in the current chart area contains any of the above words, but it is empirically known that the chart title is usually located at the upper or upper left of the chart area as shown in FIG. 2, FIG. 26, FIG. 27 and FIG. 28, the distances of all valid text blocks in the chart area from the vertex at the upper left corner and the center point of the upper border of the chart area are calculated. A valid text block closest to the vertex at the upper left corner or the center point of the upper border of the chart area is taken as the title of the chart. In addition, sometimes the title is displayed in multiple lines, as shown in FIG. 15. In such case, the valid text blocks in the vertical direction are needed to be combined to get the complete title, as “FIG. 3: Revenue breakdown: bras & intimate wear still accounts for the largest share”.

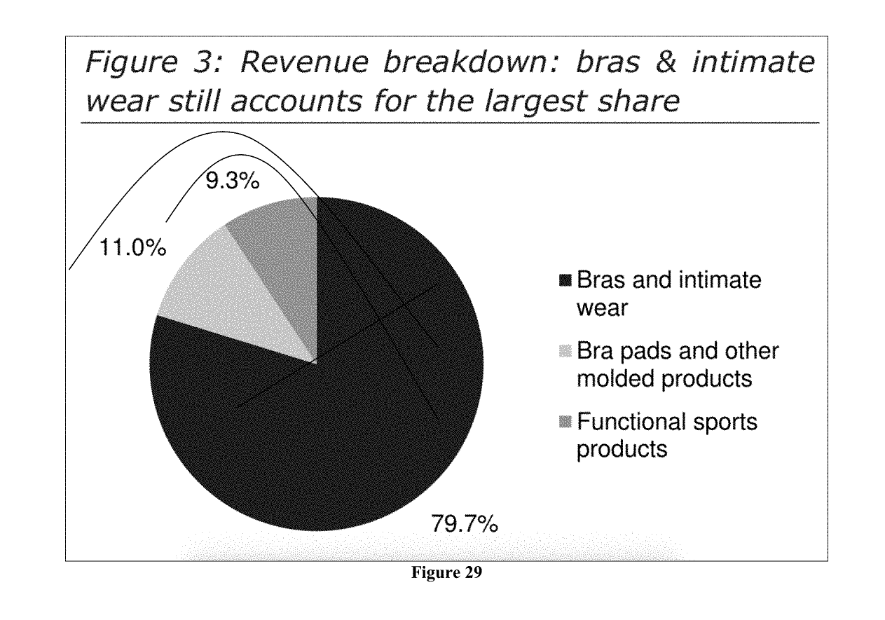

In an embodiment, the legend position in a chart is usually not fixed. Moreover, a complete legend is usually composed of small icons and valid text blocks in similar heights, and usually the small icon is on the left while the valid text block is on the right. A plurality of legend objects can be arranged horizontally, vertically, or in a grid, as shown in FIGS. 15, 17, and 22. When the legend of the chart is parsed by using Step 14, the valid text blocks and the icons in the chart area are usually traversed, according to coordinate information of these valid text blocks and the icons. Whether the icon and the valid text block are highly similar and whether the valid text block is located immediately to the right side of the icon (that is, the distance is short) are determined, if yes, the icon and valid text block are combined as the legend of the chart. Sometimes word information of a legend is divided into a plurality of lines, as shown in FIG. 15. In such case, the lines need to be combined vertically up to down to get three complete legends, which are respectively “Bras and intimate wear”, “Bra pads and other molded products” and “Functional sports products”. The parsed sector objects and the legends are traversed, and the sectors and legends of the same color are matched, as shown in FIG. 29. A curve in FIG. 29 is only configured to explain a part indicated by the legend of the corresponding color in this embodiment, these curves are not comprised in the chart redrawn by using actually obtained chart information.

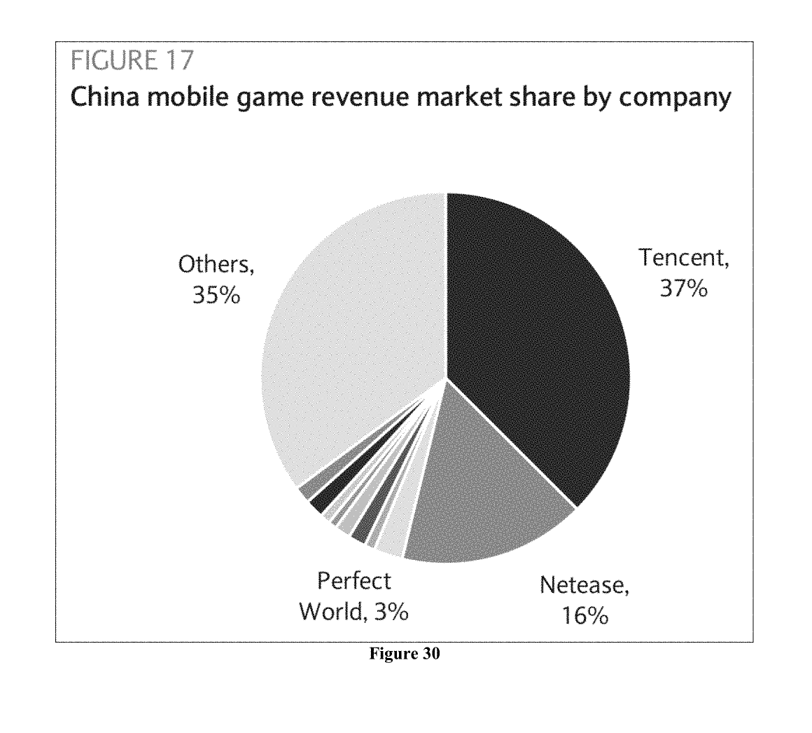

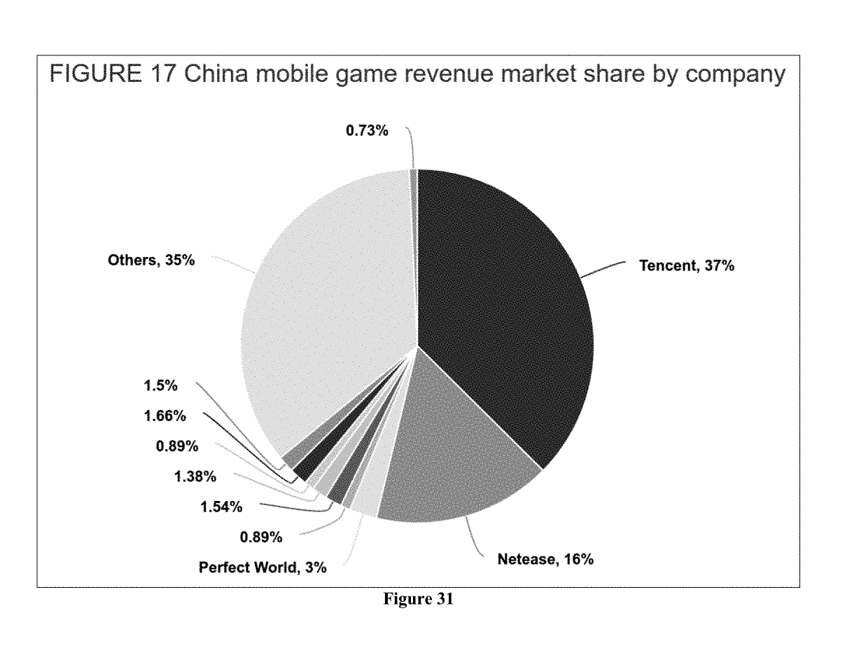

In an embodiment, when the graphic object of which the type is the sector object is comprised in the chart area, it is usually needed to be determined whether the valid text block indicating information on a proportion of the sector object is provided inside or in the vicinity of the sector object. If an original graph marks the information the proportion of the sector inside or in the vicinity of each sector, as shown in the pie chart in FIG. 2, the information of the proportion is directly used. If the proportion of each sector is not marked, the angle of the sector is calculated and divided by 360, and the result is taken as the proportion of the sector. As shown in the pie chart in FIG. 30, only the proportions of a part of the sectors are marked in the pie chart, and the proportions of the other sectors are not marked, the proportion of each sector may be calculated according to this principle that the sum of angles of all sectors are 360°, after the angle of the sector without marking the information of the proportion is calculated, a resulted angle is divided by 360, the information of the proportion of each sector may be obtained, the result is shown in FIG. 31.

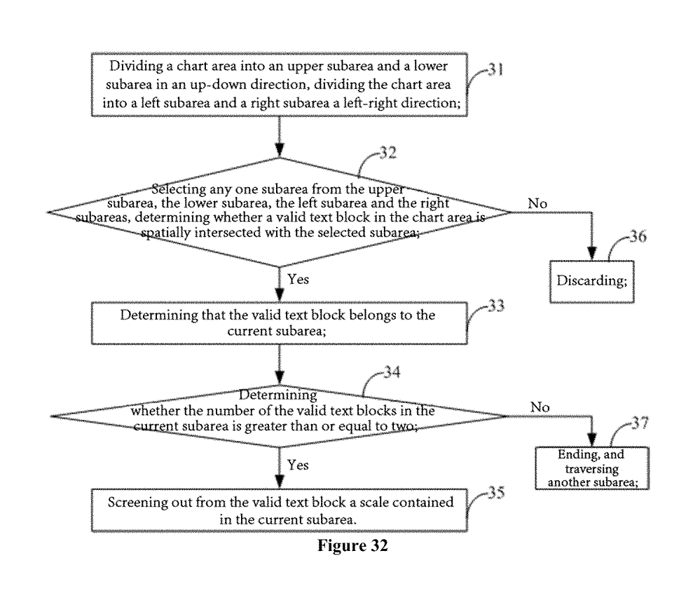

In an embodiment, the scale information contained in the current chart area is usually obtained according to the step shown in FIG. 32. As shown in FIG. 32, the method mainly comprises the following steps:

In Step 31, the chart area is divided into an upper subarea and a lower subarea in an up-down direction, and divided into a left subarea and a right subarea in a left-right direction.

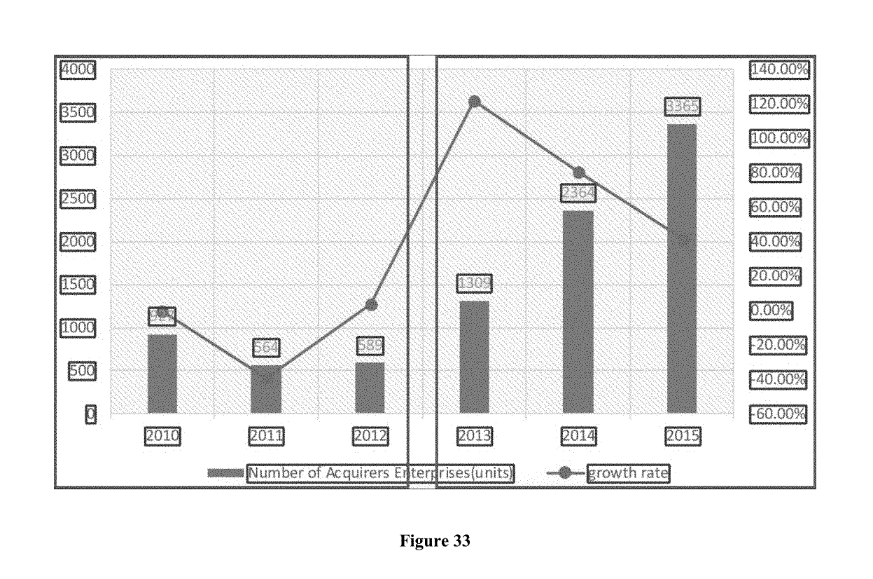

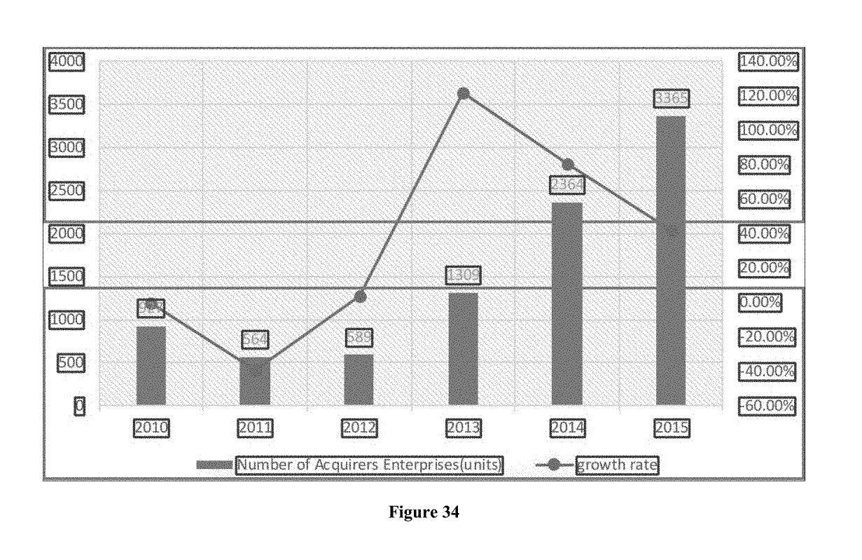

An embodiment of the present application provides an example of a combined view, as shown in FIG. 33, after being divided in the left-right direction, the left subarea and the right subarea are obtained, as shown by a rectangular box in the figure. FIG. 34 is a view of the upper subarea and the lower subarea obtained by dividing the chart in FIG. 33 in the up-down direction.

In Step 32, one subarea of the upper subarea, the lower subarea, the left subarea and the right subarea obtained by dividing with step 32 is randomly selected, it is determined whether the valid text blocks located in the chart area are spatially intersected with the selected current subarea. If it is not spatially intersected, it is indicated that the valid text block does not belong to the current subarea, the valid text block is discarded and the next valid text block is re-selected (Step 36). If the spatial intersection is found, Step 33 is carried out.

In Step 33, it is determined that the valid text block belongs to the current subarea. When it is determined that a certain valid text block belongs to the current subarea, the valid text block is usually saved in a text block container.

In Step 34, it is determined whether the number of valid text blocks in the current subarea is greater than or equal to two.

After all valid text blocks in the chart area are traversed, it is determined whether the number of the valid text blocks in the text block container is not less than two.

In Step 35, if the number of the valid text blocks in the current subarea is greater than or equal to two, the scale contained in the current subarea is screened out from the valid text block.

Typically, only when the number of the valid text blocks contained in a certain subarea is less than two, it is determined that no scale information is present in the subarea, another subarea continues to be traversed (Step 37). If the number equals to two, and if a spacing between the left and right sides of these two text blocks is greater than 50% of the height of the chart area or less than 10% of the height of the chart area, it is determined that no scale information is present in the subarea; if the spacing between the upper and lower sides of the two text blocks is greater than 80% of the width of the chart area or less than 10% of the width of the chart area, it is also determined that no scale information is present in the subarea.

Step 32 to Step 35 are repeated until the upper subarea, the lower subarea, the left subarea and the right subarea are traversed to determine whether the scale information is provided in each subarea, and the scale information in the subarea is obtained when the scale information is provided in a certain subarea.

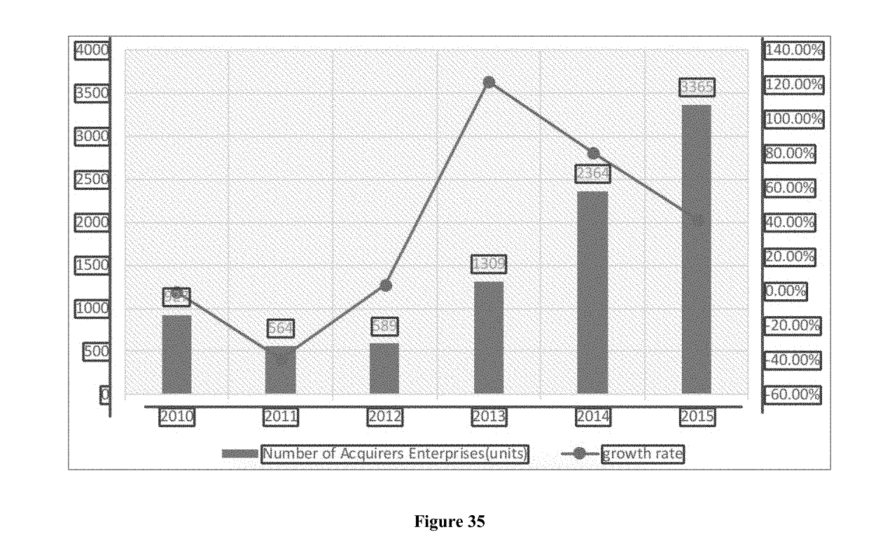

In an embodiment, after the current subarea is screened out from all the valid text blocks, all the subareas may comprise a scale, or only a part of the subareas may contain the scale, if the number of the valid text blocks contained in certain a subarea is greater than or equal to two, it needs further to be determined whether these valid text blocks spatially meet the following rules: a right edge of a left scale is approximately aligned in an X direction, a left edge of a right scale is approximately aligned in the X direction, an upper edge of a lower scale is approximately aligned in the X direction, a lower edge of an upper scale is approximately aligned in a Y direction, the left and the right scales are spaced approximately the same in the Y direction, the upper and the lower scales are spaced approximately the same in the X direction, for details, see a scenario shown in FIG. 35.

Specifically, if the number of the valid text blocks contained in the left subarea is greater than or equal to two, it is determined whether the right edge of the valid text block in the left subarea is substantially aligned in the vertical direction and the valid text blocks that are approximately aligned vertically and equally spaced in the vertical direction in the right edge are screened out and used as the scale of the left subarea.

If the number of the valid text blocks contained in the lower subarea is greater than or equal to two, it is determined whether the upper edge of the valid text block in the lower subarea is approximately aligned in the horizontal direction and the valid text blocks that are approximately aligned in the horizontal direction and spaced equally in the horizontal direction in the upper edge are screen out and used as the scale of the lower subarea.

If the number of the valid text blocks contained in the right subarea is greater than or equal to two, it is determined whether the left edge of the valid text block in the right subarea is substantially aligned in the vertical direction and the valid text blocks that are approximately aligned in the vertical direction and equally spaced in the vertical direction in the left edge are screened out and used as the scales of the right subarea.

If the number of the valid text blocks contained in the upper subarea is greater than or equal to two, it is determined whether the lower edge of the valid text block in the upper subarea is approximately aligned in the horizontal direction and the valid text blocks that are approximately aligned in the horizontal direction and spaced equally in the horizontal direction in the lower edge are screened out and used as the scale of the upper subarea.

In addition, the scales of the subareas on the same side semantically have some similarities, such as a numerical type, a time type or other word types. If most of the scales of the current subarea meet a certain type, and a very small number of the scales do not meet this type, the valid text block that does not meet this type is filtered out.

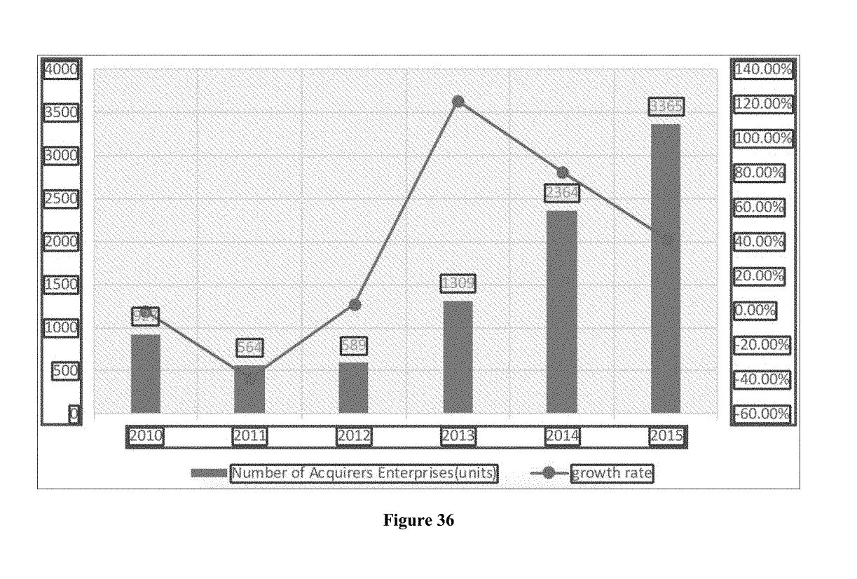

For some word patterns with inclined scales, the word patterns may be identified and converted into the scales with the OCR model. If titles are the same and the legends are similar, it is possible for the scale to have a plurality of lines, the adjacent valid text block in the vertical direction is needed to be tried to be extended and the complete scale information is then obtained, as shown in FIG. 36.

In one embodiment, in order to further analyze the chart information, after the upper subarea, the lower subarea, the left subarea and the right subarea are traversed, it is determined whether the scale information is included in each subarea, in the embodiments of the present application, semantic analysis is usually performed on the scales in each subarea to determine the attributes of the scales. Often, the scale attribute usually comprises three types: the numeric type, the time type, and a label type. The scale of the numeric type is shown on the left or right scale of FIG. 17, FIG. 26 and FIG. 28, a unit symbol thereof is ignored, a float point value corresponding to each scale is saved. A scale of the label type is shown as the lower scale in FIG. 27. A scale of the time type is shown as the lower scale in FIG. 26 and FIG. 33.

First, it is determined whether the scale can be converted to a time sequence or a numerical sequence, if the scale can be converted into the time sequence, the scale is set as the time type, and the time stamp corresponding to each scale after each scale is converted into the time sequence is saved. When the scale is converted into the time sequence, it is usually necessary to calculate the time stamp corresponding to each scale. the time stamp refers to the total number of seconds since Jan. 1, 1970, 00:00:00 GMT (Jan. 1, 1970, Beijing time 08:00 00:00), for example, Beijing time Oct. 31, 2017 12:30:50 corresponds to a time stamp of 1509424250. If the scale may be converted to the numerical sequence, the scale is set as the numeric type and the floating point corresponding to each scale after each scale is converted to the numeric type is saved. if the scale may not be converted to the time sequence or may not be converted to the numerical sequence, the scale is set as the label type.

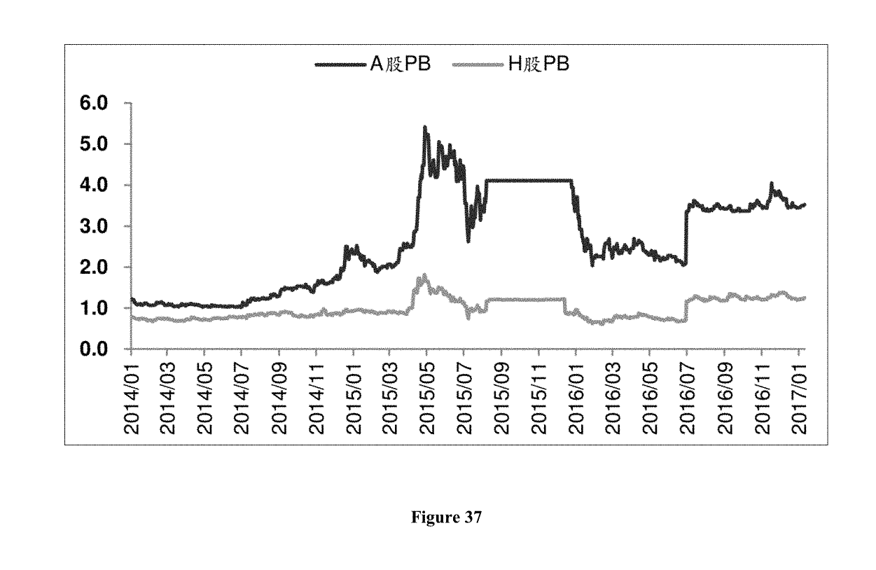

After the aforesaid parsing process, after all valid graphic objects in the chart area are obtained, the number of valid vertexes of the broken line objects in the chart area is calculated when the graphic object is the broken line type, if the number of the valid vertexes of the broken lines is greater than the number of upper scales or lower scales, the coordinate of each vertex is needed to be obtained. As shown in FIG. 37, the number of the valid vertexes of the broken line is greater than the number of X-axis scales. For each vertex, an X-axis coordinate of each vertex is needed to be calculated with a difference method. As shown in FIG. 33, the number of the valid vertexes of the broken line is equal to the number of X-axis scales. In this case, it is only necessary to find, for each vertex in the X direction, a scale closest to each vertex as the X-axis coordinate of the vertex.

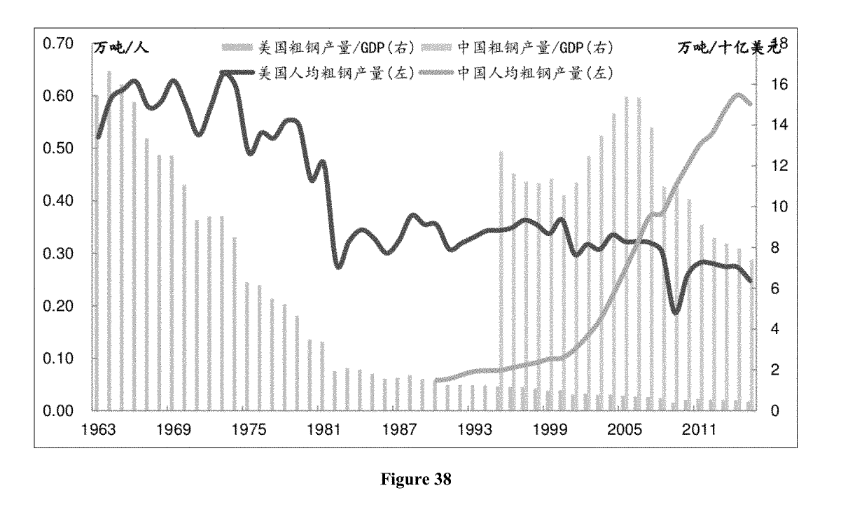

When the graphic object is a vertical columnar type, the number of valid rectangles in the chart area is counted. If the number is greater than the number of the upper scales or the number of the lower scales, it is necessary to obtain the X-axis coordinate of each rectangle by the difference method. The coordinate here refers to the X-axis coordinate of the center point of the rectangle. Otherwise, only the scale closest to the center point thereof is needed to be found for each rectangle in the X direction. As shown in FIG. 38, the number of the rectangles is larger than the number of the X-axis scales, the X-axis coordinate of the center point of each rectangle needs to be calculated by an interpolation method. As shown in FIG. 33, the number of the rectangles is equal to the number of the X-axis scales, in this case, only one scale closest to the center point of each rectangle is needed to be found in the X direction, this scale can be used as the X-axis coordinate of each rectangle.

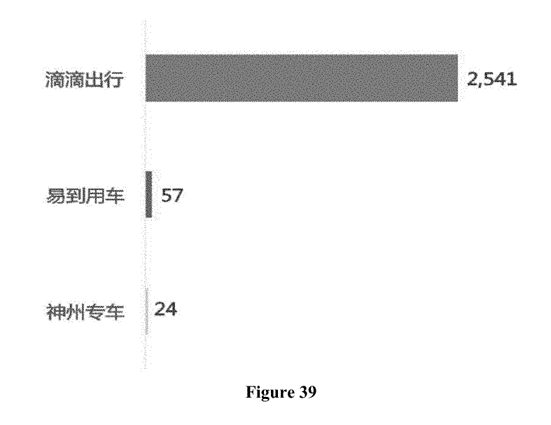

When the graphic object is a horizontal columnar type, the number of valid rectangles in the chart area is counted, if the number is greater than the number of the left scales or the number of the right scales, it is necessary to obtain the X axis coordinate of each rectangle by the interpolation method. Otherwise, it is only necessary to find the scale closest to the center point of each rectangle in the Y direction, and use the scale as the Y coordinate of each rectangle, as shown in FIG. 39.

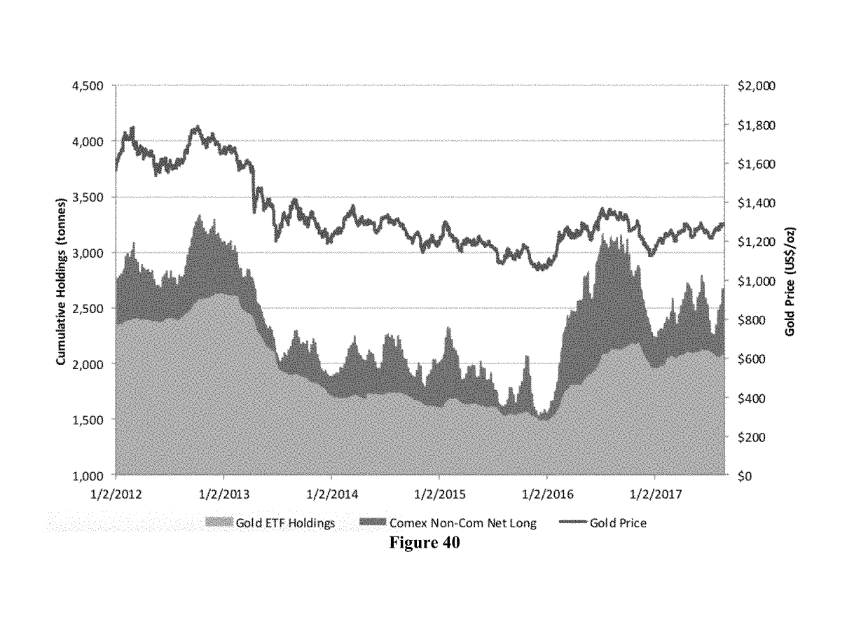

When the graphic object is an area type, the graphic object is processed in a similar way as the broken line object. FIG. 40 is an example of a combined view according to some embodiments of the present application, which comprises a broken line graph and an area graph, the area graph has two: one is dark gray and the other is light gray, the dark gray area graph is above the light gray area graph. When the two area objects are parsed, the number of the valid vertexes of the contour broken line of the two area objects in the chart area may be separately calculated according to a parsing method of the broken line object, as is evident from FIG. 40, the number of the valid vertexes is greater than the number of the X-axis scales. Therefore, it is necessary to calculate a quantization value of the X-axis scale corresponding to each vertex by the difference method to obtain the X-axis coordinate of each vertex. Similarly, the Y-axis coordinate of each vertex is calculated by the difference method.

In addition to the above method, the idea of calculus may also be applied. The light gray area graph may be subdivided into a plurality of consecutively adjacent rectangular object sets in very small width along the X axis, the X-axis coordinate and Y-axis coordinate of each center point of the top and bottom of each rectangular object in the set are respectively obtained by the interpolation method, Specific difference steps are similar to a method of the X-axis coordinate and the Y-axis coordinate of the vertex of the broken line. the Y-axis coordinates of center points of the top and bottom of each rectangular object are subtracted to be taken as a Y-axis attribute value of the rectangle object, the X axis coordinate of the center point of the top or bottom is taken as the X axis attribute of the rectangle object.

And then the same method is used to obtain the X-axis coordinate and the Y-axis coordinate of the center points of the top and bottom of each rectangular object in the rectangular object set corresponding to the dark gray area graph.

When the area chart is divided into rectangular objects, the vertexes on the broken line contour of the area chart may be referred to, and each vertex is taken as the center point of the top of each rectangular object to divide the area graph.

In general, when the scale is the time type or the numerical type, the number of the vertexes of valid broken line objects in the chart area is counted, when the number of the vertexes is greater than the number of the scales comprised in the lower subarea (or the upper subarea) and the number of the scales comprised in the lower subarea (or the upper subarea) is not less than 2, when the interpolation method is used to obtain the scale of each vertex in the X-axis direction, a perpendicular line to the X-axis from each vertex in the vertical direction is usually made, the distances between a foot of the perpendicular line and two adjacent scales are obtained, the time stamps or the floating-points corresponding to two adjacent scales are combined, a linear difference method is used to calculate the X-axis coordinate corresponding to each vertex. Similarly, a perpendicular line to the Y-axis from each vertex in the horizontal direction is usually made, the distances between the foot of the perpendicular line and two adjacent scales are obtained, the time stamps or the floating-points corresponding to two adjacent scales are combined, the linear difference method is used to calculate the Y-axis coordinate corresponding to each vertex.

When the scale type is the label type, counting the number of the vertexes of the valid broken line object in the chart region is counted, if the number of the vertexes is greater than the number of the scales comprised in the lower subarea (or the upper subarea) and the number of the scales comprised in the lower subarea (or the upper subarea) is not less than two, a perpendicular line to the X-axis from the vertex in the vertical direction is made, the distances between the foot of the perpendicular line and two adjacent scales are obtained, the scale that is closer to the foot of the perpendicular line is used as the X-axis coordinate corresponding to the vertex. Similarly, a perpendicular line to the Y-axis from the vertex in the horizontal direction is made, the distances between the foot of the perpendicular line and two adjacent scales are obtained, and the scale that is closer to the foot of the perpendicular line is taken as the Y-axis coordinate corresponding to the vertex.

When the scale is the time type or the numerical type, if the columnar object is the columnar object in the vertical direction, the number of the valid columnar objects in the chart area is counted. if the number of the valid columnar objects is greater than the number of scales contained in the lower subarea (or upper subarea) and the number of the scales comprised in the lower subarea (or the upper subarea) is not less than two, the distance between the foot of the perpendicular line and two adjacent scales are obtained, the time stamp or the floating-point corresponding to the scale is combined, the linear difference method is used to calculate the X-axis coordinate corresponding to the columnar object. Similarly, the perpendicular line is made for the Y-axis at the center point of the columnar object in the horizontal direction, the distance between the foot of the perpendicular line and two adjacent scales is obtained, the time stamp or the floating-point corresponding to the scale is combined, the linear difference method is used to calculate the Y-axis coordinate corresponding to the columnar object.

When the scale is the label type, if the columnar object is the columnar object in the vertical direction, the number of the valid columnar objects in the chart area is counted. If the number of the valid columnar objects is greater than the number of the scales comprised in the lower side area (or the upper side area) and the number of the scales comprised in the lower side area (or the upper side area) is not less than 2, the perpendicular line is made to the X axis from the center point of the columnar object in the vertical direction, the distances between the foot of the perpendicular line and two adjacent scales are obtained, the scale that is closer to the foot of the perpendicular line is used as the X-axis coordinate corresponding to the columnar object. Similarly, a perpendicular line is made to the Y-axis at the center point of the columnar object in the horizontal direction, the distances between the foot of the perpendicular line and two adjacent scales are obtained, the scale that is closer to the foot of the perpendicular line is used as the Y-axis coordinate corresponding to the columnar object.

In addition, a certain word object configured to mark certain real attribute information may be provided inside the chart area, for example, the word object that represents the value attribute of the vertex is marked in the vicinity of the vertex of the broken line mark, the word object that represents the numerical attribute of the columnar object is marked at the top, the bottom or the middle of a vertical column, or the word object that represents a column numerical attribute is marked in the vicinity of the left end, the right end or the middle of the horizontal column, utilizing these mark information may greatly optimize and improve the accuracy of the parsed chart information. Specific processing is as follows:

The number of the word objects that represent tag attribute information in the chart area is counted, if the number thereof is less than the number of the vertexes of the broken lines or the number of columns, the number is not matched, it is indicated that each object may not have a tag attribute. For the broken line object, the unique tag attribute for each vertex is provided within a certain bound thereof with the nearest neighbor method, the vertex in a dotted line box as shown in FIG. 22 corresponds to a unique tag attribute of 23%. For a vertical columnar object, a top center point is provided at each rectangle located above the x-coordinate axis, or a bottom center point is provided at each rectangle located below the x-coordinate axis, for the top center point or the bottom center point of each column, the unique tag attribute is provided within the certain bound thereof with the nearest method, if not provided, the inner center point of the rectangle may be processed in a similar way. As shown in FIG. 27 and FIG. 33, one tagged attribute value is provided near the top center point or the bottom center point of each rectangle. For a horizontal columnar object, a right-side center point is provided at each column located at the right side of the Y coordinate axis, or a left-side center point is provided at each column located at the left side of the Y coordinate axis, the unique tag attribute of each column is provided within the certain bound of the right-side center point thereof or the left-side center point thereof, if not provided, the inner center point of the column may try to be processed in the similar way again. As shown in FIG. 39, one tagged attribute value is provided near the right side of each column. For area object, the number of internal points is very huge, no case of the attribute information is usually tagged around the vertex thereof.

With the embodiments of the present application, the chart in the file page may be identified, and the data in the chart may be extracted. The embodiment of the present application obtains the chart information stored in the file comprising a word, location information of the word in the file page, various graphic elements and location information of the graphic element in the file page by parsing the contents of the file pages in various formats, finds a chart area in the file page by combining these information, further analyzes this area to obtain a chart element such as a title, a legend, a coordinate axis, a coordinate axis scale word, a broken line, and a column and so on, redraws the chart in the file with these information, and may perform search or analysis and other processing processes on these elements.

Based on the same inventive concept as the method for extracting the chart information in the file shown in FIG. 1, an embodiment of the present application further provides a device as described in the following embodiments. Since the principle of the device for solving the problem is similar to the method of extracting the chart information in the file in FIG. 1, the implementation in the device may refer to the implementation of the method for extracting the chart information in the file in FIG. 1, and details are not repeatedly described herein.

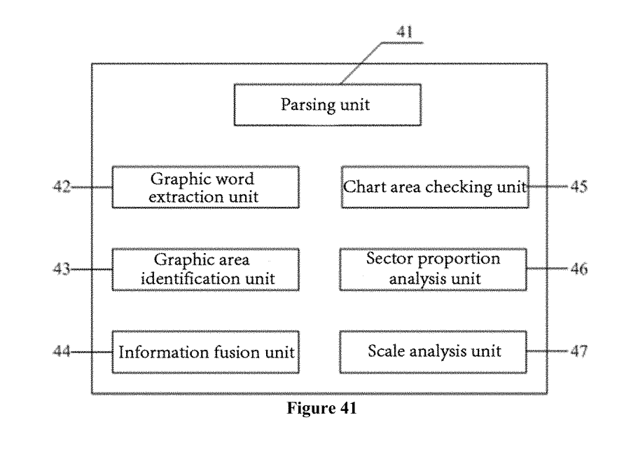

In another embodiment, an embodiment of the present application further provides a device for extracting the chart information in the file, the structure of which is shown in FIG. 41, the device mainly comprises a parsing unit 41, a graph-and-word extraction unit 42, a chart area identification unit 43, and an information fusion unit 44.

The parsing unit is configured to parse an underlying data stored in a to-be-identified page and combine the underlying data into a data block according to a behavior identifier in the underlying data. The graph-and-word extraction unit 42 is configured to extract a graphic object and a word object respectively from the data block and obtain location information of the word object and the graphic object in the to-be-identified page. The chart area identification unit 43 is configured to identify a chart area in the to-be-identified page according to the graphic object and the word object. The information fusion unit is configured to perform data fusion on the word object and the graphic object in the chart area to obtain chart information contained in the chart area; wherein the chart information comprises at least one of a title, a legend, a scale, and a scale attribute.

In an embodiment, the chart area identification unit 43 is specifically configured to: a) randomly selecting one graphic object from the graphic objects and taking the area where the graphic object is located as a candidate graphic area; b) determining whether most of the graphic objects and/or the word objects adjacent to the candidate chart area are located inside the candidate chart area; c) if yes, combining the graphic objects and/or the word objects adjacent to the candidate chart area with the candidate chart area to obtain a new candidate chart area. Repeating steps b) and c) until most of the graphic objects and/or the word objects adjacent to the newest candidate chart area are located outside the newest candidate chart area, and taking the newest candidate chart area as the chart area of the to-be-identified page.

In an embodiment, the device further comprises a chart area checking unit 45 configured to determine whether the size of the candidate chart area is too large or too small; when the size of the candidate chart area is neither too large nor too small, it is determined that the candidate chart area is a valid chart area.

In an embodiment, the chart area checking unit 45 is specifically configured to: determine whether the width of the candidate chart area is greater than 80% of the width of the to-be-identified page, and whether the height of the candidate chart area is greater than 85% of the height of the to-be-identified area, if yes, determine that the size of the candidate chart area is too large; determine whether the width of the candidate chart area is less than 10% of the width of the to-be-identified page, and whether the height of the candidate chart area is less than 7% of the height of the to-be-identified page, if yes, determine that the size of the candidate chart area is too small.

In an embodiment, when the graphic text extraction unit 42 extracts the graphic object and the word object respectively from the data block, the device specifically comprises: extracting filled elements and/or contour elements from the graphic object, parsing out the colors and the paths of the filled elements and/or the contour elements; and determining a type of the graphic object according to the colors and the paths of the filled elements and/or the contour elements; the type of the graphic object comprising at least one of a sector object, a broken line object, an area object, a columnar object, a coordinate axis, a coordinate axis scale line, an auxiliary line, an icon, and a bitmap object, when the graphic object comprises the bitmap object, identifying the word object contained in the bitmap object by using an OCR model; reconstructing semantically related word objects in close proximity into a valid text block according to location information of the word object and semantic information of the word object; wherein semantic information comprises one or more of a character type, a font type, a font size, a font color, and a font direction.

In an embodiment, the information fusion unit 44 is specifically configured to: traverse the valid text blocks located in the chart area, and determine whether a valid text block is a title of a chart according to a preset semantic library; if no, calculate the distance between each valid text block and a vertex at an upper left corner of the chart area and the distance between the valid text block and a center point of an upper border of the chart area, and take, as a title of a chart, the valid text block closest to a vertex at the upper left corner or a center point of an upper border of the chart area.

In an embodiment, the information fusion unit 44 is further configured to: traverse the valid text blocks and icons in the chart area, and determine whether an icon and a valid text block are highly similar and whether the valid text block is immediately to the right side of the icon, according to coordinate information of the valid text block and the icon; if yes, the icon and valid text block are combined as a legend of the chart.

In an embodiment, the device further comprises a sector proportion analysis unit 46. When the graphic object of which the type is a sector object is contained in the graphic area, the sector proportion analysis unit 46 is specifically configured to: determine whether a valid text block indicating information on proportion of a sector object is present inside or in the vicinity of the sector object; take the valid text block as the proportion of the sector object when the valid text block indicating the information on the proportion of the sector object is present inside or in the vicinity of the sector object; calculate an angle of a sector and divide the angle by 360° when the valid text block indicating the information on the proportion of the sector object is not present inside or in the vicinity of the sector object, and take the obtained result as the proportion of the sector object.

In an embodiment, the device further comprises a scale analysis unit 47 specifically configured to: a) divide the chart area into an upper subarea and a lower subarea in an up-down direction, and divide the chart area into a left subarea and a right subarea in a left-right direction; b) randomly select any one subarea of the upper subarea, the lower subarea, the left subarea and the right subarea, and determine whether the valid text block in the chart area is spatially intersected with the selected current subarea; c) if yes, determine that the valid text block belongs to the current subarea; d) determine whether the number of the valid text blocks in the current subarea is greater than or equal to two; e) screen out, from the valid text block, the scale contained in the current subarea if the number of the valid text blocks in the current subarea is greater than or equal to two; repeat steps b) to e) until the upper subarea, the lower subarea, the left subarea and the right subarea are completely traversed.

In an embodiment, when the scale contained in the current subarea is screened out from the valid text block by using the scale analysis unit 47, the followings are specifically comprised: screening out, from the valid text blocks in the left subarea, the valid text block of which a right edge is substantially aligned in a vertical direction and equally spaced in the vertical direction, to take the valid text block as a scale of the left subarea, if the current subarea is the left subarea; screening out, from the valid text blocks in the lower subarea, the valid text block of which a upper edge is substantially aligned in a horizontal direction and equally spaced in the horizontal direction, to take the valid text block as a scale of the lower subarea, if the current subarea is the lower subarea; screening out, from the valid text blocks in the right subarea, the valid text block of which a left edge is substantially aligned in the vertical direction and equally spaced in the vertical direction, to take the valid text block as a scale of the left subarea, if the current subarea is the right subarea; screening out, from the valid text blocks in the lower subarea, the valid text block of which a lower edge is substantially aligned in the horizontal direction and equally spaced in the horizontal direction, to take the valid text block as a scale of the upper subarea, if the current subarea is the upper subarea.

In an embodiment, after the upper subarea, the lower subarea, the left subarea and the right subarea are traversed by using the scale analysis unit 47, the scale analysis unit 47 is further configured to: semantically analyze the scale contained in each obtained subarea respectively to determine whether the scale can be converted to a time sequence or a numerical sequence; if the scale can be converted into the time sequence, the scale is set as the time type, and a time stamp corresponding to each scale after the scale is converted into the time sequence is saved; if the scale can be converted to the numerical sequence, the scale is set as the numeric type and the floating point corresponding to each scale after the scale is converted to the numeric type is saved; if the scale can be converted to neither the time sequence nor the numerical sequence, the scale is set as a label type.

In an embodiment, when the scale is the time type or the numeric type, the scale analysis unit 47 is further configured to: count the number of vertexes of the valid broken line object in the chart area; determine whether the number of vertexes is greater than the number of scales contained in the lower subarea or the upper subarea and whether the number of scales contained in the lower subarea or the upper subarea is not less than two; if yes, make a perpendicular line to an X-axis from the vertex in a vertical direction, obtain the distances between a foot of the perpendicular line and two adjacent scales, use a linear difference method to calculate an X-axis coordinate corresponding to the vertex according to the time stamp or the floating point corresponding to the scale; make a perpendicular line to a Y-axis from the vertex in the horizontal direction, obtain the distances between the foot of the perpendicular line and two adjacent scales, use the linear difference method to calculate a Y-axis coordinate corresponding to the vertex according to the time stamp or the floating-point corresponding to the scale.

In an embodiment, when the scale type is the label type, the scale analysis unit 47 is further configured to: count the number of vertexes of the valid broken line object in the chart area; determine whether the number of the vertexes is greater than the number of the scales contained in the lower subarea or the upper subarea, and whether the number of scales contained in the lower subarea or the upper subarea is not less than two; if yes, make a perpendicular line to the X-axis from the vertex in the vertical direction, obtain the distances between the foot of the perpendicular line and two adjacent scales, take a scale with a shorter distance from the perpendicular line as the X-axis coordinate corresponding to the vertex; make a perpendicular line to the Y-axis from the vertex in the horizontal direction, obtain the distances between the foot of the perpendicular line and two adjacent scales, and take the scale with the shorter distance from the perpendicular line as the Y-axis coordinate corresponding to the vertex.

In an embodiment, when the scale is the label type or the numerical type, the scale analysis unit 47 is further configured to: determine whether the columnar object is the columnar object in the vertical direction; if yes, count the number of the valid columnar objects in the chart area; determine whether the number of the columnar objects is greater than the number of scales contained in the lower subarea or the upper subarea and whether the number of scales contained in the lower subarea or the upper subarea is not less than two; if yes, make a perpendicular line to the Y-axis from the center point of the columnar object in the vertical direction, obtain the distances between the foot of the perpendicular line and two adjacent scales, use the linear difference method to calculate the X-axis coordinate corresponding to the columnar object according to the time stamp or the floating point corresponding to the scale; make a perpendicular line to the Y-axis from the center point of the columnar object in the horizontal direction, obtain the distances between the foot of the perpendicular line and two adjacent scales, use the linear difference method to calculate the Y-axis coordinate corresponding to the columnar object according to the time stamp or the floating-point corresponding to the scale.

In an embodiment, when the scale is the label type, the scale analysis unit 47 is further configured to: determine whether the columnar object is the columnar object in the vertical direction; if yes, count the number of the valid columnar objects in the chart area; determine whether the number of the columnar objects is greater than the number of scales contained in the lower subarea or the upper subarea and whether the number of scales contained in the lower subarea or the upper subarea is not less than two; if yes, make a perpendicular line to the X-axis from the center point of the columnar object in the vertical direction, obtain the distances between the foot of the perpendicular line and two adjacent scales, take the scale with the shorter distance from the perpendicular line as the X-axis coordinate corresponding to the columnar object; make a perpendicular line to the Y-axis from the center point of the columnar object in the horizontal direction, obtain the distances between the foot of the perpendicular line and two adjacent scales, take the scale with the shorter distance from the perpendicular line as the Y-axis coordinate corresponding to the columnar object.

With the embodiments of the present application, the chart in the file page can be identified, and the data in the chart is extracted. The embodiment of the present application obtains the chart information stored in the file comprising a word, location information of the word in the file page, various graphic elements and location information of the graphic element in the file page by parsing the contents of the file pages in various formats, finds a chart area in the file page by combining these information, further analyzes this area to obtain a chart element such as a title, a legend, a coordinate axis, a coordinate axis scale word, a broken line, and a column and so on, redraws the chart in the file with these information, and may perform search or analysis and other processing processes on these elements.

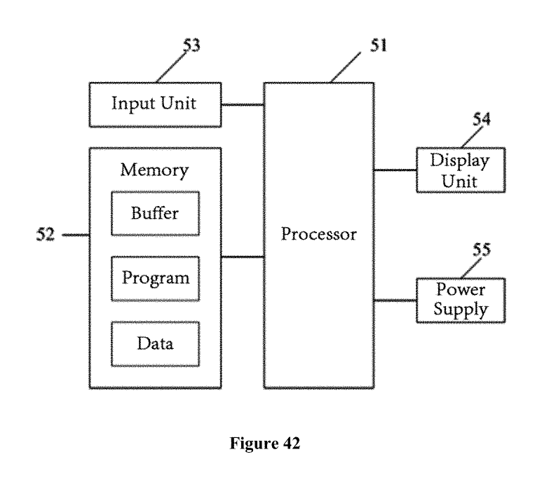

FIG. 42 is a view of a system composition of an electronic device according to an embodiment of the present application. As shown in FIG. 42, the electronic device may comprise a processor 51 and a memory 52, wherein the memory 52 is coupled to the processor 51. It is noteworthy that this figure is exemplary, other types of structures may also be used to supplement or replace the structures for realizing data extraction, graph redrawing, communication, or other functions.

In an embodiment, the processor 51 can be configured to perform the following controls: parsing an underlying data stored in a to-be-identified page, combining the underlying data into a data block according to a basic semantics and a coordinate in the underlying data; extracting the graphic object and the word object from the data block respectively, obtaining the location information of the word object and the graphic object in the to-be-identified page; identifying the chart area in the to-be-identified page according to the graphic object and the word object; performing data fusion on the word object and the graphic object in the chart area to obtain the chart information contained in the chart area; wherein the chart information comprises one or more of the title, the legend, the scale, and the scale attribute.

When the chart area in the to-be-identified page is identified according to the graphic object and the word object, the processor 51 may further be configured to perform the following operations: a) randomly selecting one graphic object from the graphic objects and taking the area where the graphic object is located as a candidate graphic area; b) determining whether most of the graphic objects and/or the word objects adjacent to the candidate chart area are located inside the candidate chart area; c) if yes, combining the graphic objects and/or the word objects adjacent to the candidate chart area with the candidate chart area to obtain a new candidate chart area; repeating steps b) and c) until most of the graphic objects and/or word objects adjacent to the newest candidate chart area are located outside the newest candidate chart area, and taking the newest candidate chart area as the chart area of the to-be-identified page, wherein information such as the above graphic object, the word object, the candidate chart area, etc., may be stored in the memory 52.

The processor 51 is configured to perform the following operations: determine whether the size of the candidate chart area is too large or too small; when the size of the candidate chart area is neither too large nor too small, determine that the candidate chart area is a valid chart area.

When it is determined whether the size of the candidate chart area is too large or not, the processor 51 is configured to perform the following operations: determining whether the width of the candidate chart area is less than 80% of the width of the to-be-identified page, and whether the height of the candidate chart area is less than 85% of the height of the to-be-identified page, if yes, determining that the size of the candidate chart area is too large; determining whether the width of the candidate chart area is less than 10% of the width of the to-be-identified page, and whether the height of the candidate chart area is less than 7% of the height of the to-be-identified page, if yes, determining that the size of the candidate chart area is too small.

When the graphic object and the word object are extracted from the data block respectively, the processor 51 is configured to perform the following operations: extracting the filled elements and/or the contour elements from the graphic object, parsing out the colors and paths of the filled elements and/or the contour elements; determining the type of the graphic object according to the colors and the paths of the filled elements and/or the contour elements; the type of the graphic object comprising at least one of the sector object, the broken line object, the area object, the columnar object, the coordinate axis, the coordinate axis scale line, the auxiliary line, the icon, and the bitmap object, when the graphic object comprises the bitmap object, identifying the word object contained in the bitmap object by using the OCR model; reconstructing the semantically related word object in close proximity into the valid text block according to location information of the word object and the semantic information of the word object; wherein the semantic information comprises one or more of the character type, the font type, the font size, the font color, and the font direction.

When data fusion is performed on the word object and the graphic object in the chart area to obtain the chart information contained in the chart area, the processor 51 is configured to perform the following operations: traversing the valid text block located in the chart area, and determining whether a valid text block is a title of the chart according to a preset semantic library; if no, calculating the distance between each valid text block and a vertex at an upper left corner of the chart area and distance between each valid text block and a center point of an upper border of the chart area, and take as a title of a chart the valid text block closest to the vertex at the upper left corner or the center point of an upper border of the chart area.

When the data fusion is performed on the word object and the graphic object in the chart area to obtain the chart information contained in the chart area, the processor 51 is further configured to perform the following operations: traversing the valid text blocks and icons in the chart area, and determine whether an icon and a valid text block are highly similar and whether the valid text block is immediately to the right side of the icon, according to coordinate information of the valid text block and the icon; if yes, the icon and valid text block are combined as the legend of the chart.

When the graphic object of which the type is a sector object is contained in the chart area, the processor 51 is configured to perform the following operations: determining whether the valid text block indicating the information on the proportion of the sector object is present inside or in the vicinity of the sector object; when a valid text block indicating the proportion information of the sector object exists inside or in the vicinity of the sector object, taking the valid text block as the proportion of the sector object; calculating an angle of the sector and dividing the angle by 360° when the valid text block indicating the information on the proportion of the sector object is not present inside or in the vicinity of the sector object, and taking the result as the proportion of the sector object.

The processor 51 is further configured to perform the following operations: a) dividing the chart area into the upper subarea and the lower subarea in the upper-down direction, and dividing the chart area into the left subarea and the right subarea in the left-right direction; b) selecting any one subarea of the upper subarea, the lower subarea, the left subarea and the right subarea obtained by dividing with step 32, determining whether the valid text block in the chart area is spatially intersected with the selected current subarea; c) if yes, determining that the valid text block belongs to the current subarea; d) determining whether the number of the valid text blocks in the current subarea is greater than or equal to two; e) if the number of the valid text blocks in the current subarea is greater than or equal to two, screening out, from the valid text block, the scale contained in the current subarea; repeating steps b) to e) until the upper subarea, the lower subarea, the left subarea and the right subarea are completely traversed.

After the scale contained in the current subarea is screened out from the valid text block, the processor 51 is configured to perform the following operations: screening out, from the valid text blocks in the left subarea, the valid text block of which the right edge is substantially aligned in the vertical direction and equally spaced in the vertical direction, to take the valid text block as the scale of the left subarea, if the current subarea is the left subarea; screening out, from the valid text blocks in the lower subarea, the valid text blocks of which the upper edge is substantially aligned in the horizontal direction and equally spaced in the horizontal direction, to take the valid text block as the scale of the lower subarea, if the current subarea is the lower subarea; screening out, from the valid text blocks in the left subarea, the valid text block of which the left edge is substantially aligned in the vertical direction and equally spaced in the vertical direction, to take the valid text block as the scale of the right subarea, if the current subarea is the right subarea; screening out, from the valid text blocks in the lower subarea, the valid text blocks of which the lower edge is substantially aligned in the horizontal direction and equally spaced in the horizontal direction, to take the valid text block as the scale of the upper subarea, if the current subarea is the upper subarea.

After the upper subarea, the lower subarea, the left subarea, and the right subarea are completely traversed, the processor 51 is further configured to perform the following operations: semantically analyzing the scales contained in each obtained subarea respectively to determine whether the scale can be converted to the time sequence or the numerical sequence; if the scale can be converted into the time sequence, the scale is set as the time type, and the time stamp corresponding to each scale after the scale is converted into the time sequence is saved; if the scale can be converted to the numerical sequence, the scale is set as the numeric type and the floating point corresponding to each scale after the scale is converted to the numeric type is saved; if the scale can be converted to neither the time sequence nor the numerical sequence, the scale is set as the label type.

When the scale is the time type or the numeric type, the processor 51 is further configured to perform the following operations: counting the number of the vertexes of the valid broken line objects in the chart area; determining whether the number of the vertexes is greater than the number of the scales contained in the lower subarea or the upper subarea and whether the number of the scales contained in the lower subarea or the upper subarea is not less than two; if yes, making a perpendicular line to the X-axis from the vertex in the vertical direction, obtaining the distances between the foot of the perpendicular line and two adjacent scales, using the linear difference method to calculate the X-axis coordinate corresponding to each vertex according to the time stamp or the floating-point corresponding to the scale; making a perpendicular line to the Y-axis from the vertex in the horizontal direction, obtaining the distances between the foot of the perpendicular line and two adjacent scales, and using the linear difference method to calculate the Y-axis coordinate corresponding to each vertex according to the time stamp or the floating-point corresponding to the scale.

When the scale type is the label type, the processor 51 is further configured to perform the following operations: counting the number of the vertexes of the valid broken line objects in the chart area; determining whether the number of the vertexes is greater than the number of the scales contained in the lower subarea or the upper subarea and whether the number of the scales contained in the lower subarea or the upper subarea is not less than two; if yes, making a perpendicular line to the X-axis from the vertex in the vertical direction, obtaining the distances between the foot of the perpendicular line and two adjacent scales, taking the scale with the shorter distance from the perpendicular line as the X-axis coordinate corresponding to the vertex; making a perpendicular line to the Y-axis from the vertex in the horizontal direction, obtaining the distances between the foot of the perpendicular line and two adjacent scales, and taking the scale with the shorter distance from the perpendicular line as the Y-axis coordinate corresponding to the vertex.

When the scale is the time type or the numeric type, the processor 51 is further configured to: determine whether the columnar object is the columnar object in the vertical direction; if yes, count the number of the valid columnar objects in the chart area; determine whether the number of the vertexes is greater than the number of the scales contained in the lower subarea or the upper subarea and whether the number of the scales contained in the lower subarea or the upper subarea is not less than two; if yes, make a perpendicular line to the X-axis from the center point of the columnar object in the vertical direction, obtain the distances between the foot of the perpendicular line and two adjacent scales, use the linear difference method to calculate the X-axis coordinate corresponding to each vertex according to the time stamp or the floating-point corresponding to the scale; make a perpendicular line to the Y-axis from the center point of the columnar object in the horizontal direction, obtain the distances between the foot of the perpendicular line and two adjacent scales, and use the linear difference method to calculate the X-axis coordinate corresponding to each vertex according to the time stamp or the floating-point corresponding to the scale.

When the scale type is the label type, the processor 51 is further configured to perform the following operations: determining whether the columnar object is the columnar object in the vertical direction; if yes, counting the number of the valid columnar objects in the chart area; determining whether the number of the vertexes is greater than the number of the scales contained in the lower subarea or the upper subarea and whether the number of the scales contained in the lower subarea or the upper subarea is not less than two; if yes, making a perpendicular line to the X-axis from the center point of the columnar object in the vertical direction, obtaining the distances between the foot of the perpendicular line and two adjacent scales, taking the scale with the shorter distance from the perpendicular line as the X-axis coordinate corresponding to the columnar object; making a perpendicular line to the Y-axis from the center point of the columnar object in the horizontal direction, obtaining the distances between the foot of the perpendicular line and two adjacent scales, and taking the scale with the shorter distance from the perpendicular line as the Y-axis coordinate corresponding to the columnar object.

As shown in FIG. 42, the electronic apparatus may further comprise an input unit 53, a display unit 54, and a power supply 55. It is worth noting that the electronic device does not have to comprise all components shown in FIG. 42. In addition, the electronic apparatus may further comprise the components not shown in FIG. 42. Reference may be made to the prior art.

The processor 51, also sometimes referred to as a controller or an operational control, may comprise a microprocessor or other processor devices and/or logic devices, the processor 51 receives an input and controls the operation of various components of the electronic apparatus.

The memory 52 may be, for example, one or more of a buffer, a flash memory, a hard drive, a removable medium, a volatile memory, a non-volatile memory or other suitable devices, and may store configuration information of the above processor 51, instructions executed by the processor 51, recorded chart data, and the like. The processor 51 may execute a program stored in the memory 52 to realize information storage or processing and the like. In one embodiment, a buffer memory, that is, a buffer, is further comprised in the memory 52 to store intermediate information.

The input unit 53 may be, for example, a file reading device configured to provide the processor 51 with a to-be-identified file. The display unit 54 is configured to display the underlying data identified from the file, display the graphic object or the word object, and display a chart redrawn according to graphic information. The display unit may be, for example, an LCD display, but the present application is not limited thereto. The power supply 55 is configured to power the electronic apparatus.

The embodiment of the present application also provides a computer readable instruction. When the instruction is executed in the electronic apparatus, the program causes the electronic apparatus to perform operation steps comprised in the method of extracting the chart information in the file as shown in FIG. 1.

An embodiment of the present application further provides a storage medium storing the computer readable instruction, wherein the computer readable instruction causes the electronic apparatus to perform the steps comprised in the method of extracting the chart information in the file as shown in FIG. 1.

It should be understood that in various embodiments of the present application, the size of the sequence numbers of the foregoing processes does not mean the sequence of execution, the execution sequence of each process should be determined by the function and inherent logic thereof, and should not be construed as any limitation on the implementation process of the embodiments of the present application.

It should also be understood that in the embodiments of the present application, the term “and/or” is merely an association relationship that describes an associated object, indicating that there may exist three relationships. For example, A and/or B may represent three cases in which A exists alone, A and B are together, and B exists alone. In addition, the character “/” in this text generally means the objects in context are in an “or” relationship.

Those skilled in the art may be aware that units and algorithm steps of each example described in conjunction with the embodiments disclosed herein may be implemented by electronic hardware, computer software, or a combination of both, To clearly illustrate the interchangeability of hardware and software, the components and steps of the various examples have generally been described above in terms of the functionality thereof. Whether these functions are implemented by hardware or software depends on the specific application and design constraints of a technical solution. Those skilled in the art may use different methods for each particular application to achieve the described functionality, however, such an implementation should not be considered as beyond the scope of the present application.

Those skilled in the art may clearly understand that for the convenience and simplicity of the description, reference may be made to corresponding processes in the foregoing method embodiments for the specific working process of the foregoing system, device, and unit, and details are not described herein again.

With respect to several examples provided in the preset application, it shall be understood that the disclosed system, device and method may be realized through other ways. For example, the embodiment of the above device is only exemplary, for example, the division of the units is merely a logical function division, which may be further divided in actual implementation, for example, a plurality of the units or the components may be combined or may be integrated into another system, or a plurality of the features may be ignored or not executed. In addition, the mutual coupling or direct coupling or communication connection shown or discussed may be indirect coupling or communication connection through a plurality of interfaces, devices or units, and may also be electrical, mechanical or other forms of connection.

The unit described as a separate part may or may not be physically separated, The component displayed as the unit may or may not be a physical unit, that is, the component may be placed in one place or may be distributed to a plurality of network elements. A part of or all of the units may be selected according to actual needs to achieve the objective of the solution in the embodiments of the present application.

In addition, each functional unit in each embodiment of the present application may be integrated in one processing unit, or each unit may exist alone physically, or two or more units may be integrated in one unit. The above-mentioned integrated unit can be implemented in the form of hardware or in the form of software functional unit.

If the integrated unit is implemented in the form of a software functional unit and is sold or used as an independent product, the integrated unit may be stored in a computer-readable storage medium. Based on this understanding, for the part contributing to the prior art, or all or a part of the technical solutions, the technical solutions of the present application may essentially be implemented in the form of a software product, The computer software product is stored in one storage medium and comprises a plurality of instructions for enabling a computer apparatus (which may be a personal computer, a server, or a network device) to execute all or part of the steps of the method according to each embodiment of the present application. The foregoing storage medium comprises various media capable of storing a program code such as a USB flash disk, a removable hard disk, a read-only memory (ROM), a random access memory (RAM), a magnetic disk, or an optical disk and so on.

In the present application, specific embodiments are used to describe the principle and embodiments of the present application, the above description of the embodiments is only used to help understand the method and the core idea of the present application; meanwhile, those skilled in the art may make changes to the specific embodiments and the application scope according to the idea of the present application, in summary, the contents of the description should not be construed as limiting the present application.

1. A method for extracting chart information in a file performed by an electronic device having a processor, a display, and memory for storing instruction to be executed by the processor, the method comprising:
inputting, by the electronic device, a file which includes a to-be-identified page;
parsing, by the electronic device, an underlying data stored in the to-be-identified page, and combining the underlying data into a data block according to a behavior identifier in the underlying data;
extracting, by the electronic device, a graphic object and a word object from the data block respectively, and obtaining location information of the word object and of the graphic object in the to-be-identified page;
identifying, by the electronic device, a chart area in the to-be-identified page according to the graphic object and the word object; and
performing, by the electronic device, data fusion on the word object and the graphic object in the chart area to obtain the chart information contained in the chart area, wherein the chart information comprising one or more of a title, a legend, a scale, and a scale attribute.

2. The method according to claim 1, wherein the step of identifying the chart area in the to-be-identified page according to the graphic object and the word object comprises:
a) randomly selecting one graphic object from the graphic objects and taking the area thereof as a candidate chart area;
b) determining whether most of the graphic objects and/or the word objects adjacent to the candidate chart area are located inside the candidate chart area;
c) if yes, combining the graphic objects and/or the word objects adjacent to the candidate chart area with the candidate chart area to obtain a new candidate chart area;
repeating steps b) and c) on the electronic device until most of the graphic objects and/or the word objects adjacent to the newest candidate chart area are located outside the newest candidate chart area, and taking the newest candidate chart area as the chart area of the to-be-identified page.

3. The method according to claim 2, further comprising:
determining whether the size of the candidate chart area is too large or too small;
determining that the candidate chart area is a valid chart area, when the size of the candidate chart area is neither too large nor too small.

4. The method according to claim 3, wherein the step of determining whether the size of the candidate chart area is too large or too small comprises:
determining whether the width of the candidate chart area is greater than 80% of the width of the to-be-identified page and whether the height of the candidate chart area is greater than 85% of the height of the to-be-identified page; if yes, determining whether the size of the candidate chart area is too large;
determining whether the width of the candidate chart area is less than 10% of the width of the to-be-identified page, and whether the height of the candidate chart area is less than 7% of the height of the to-be-identified page; if yes, determining the size of the candidate chart area is too small.

5. The method according to claim 1, wherein the step of extracting the graphic object and the word object respectively from the data block specifically comprises:
extracting filled elements and/or contour elements from the graphic object, and parsing out colors and paths of the filled elements and/or the contour elements;
determining the type of the graphic object according to the colors and the paths of the filled elements and/or the contour elements; the type of the graphic object comprising at least one of a sector object, a broken line object, an area object, a columnar object, a coordinate axis, a coordinate axis scale line, an auxiliary line, an icon, and a bitmap object, and when the graphic object contains a bitmap object, identifying the word object contained in the bitmap object by using an OCR model; and
reconstructing semantically related word objects in close proximity into a valid text block according to location information of the word object and semantic information of the word object; wherein the semantic information comprising one or more of a character type, a font type, a font size, a font color, and a font direction.

6. The method according to claim 5, wherein the step of performing the data fusion on the word object and the graphic object in the chart area to obtain the chart information contained in the chart area comprises:
traversing the valid text blocks located in the chart area, determining whether each valid text block is a title of a chart according to a preset semantic library;
if no, calculating the distance between each valid text block and a vertex at an upper left corner of the chart area, and the distance between each valid text block and a center point of an upper border of the chart area, and taking the valid text block closest to the vertex at the upper left corner or the center point of the upper border of the chart area as the title of the chart.

7. The method according to claim 5, wherein the step of performing the data fusion on the word object and the graphic object in the chart area to obtain the chart information contained in the chart area comprises:
traversing the valid text blocks and icons in the chart area, determining whether an icon is highly similar to a valid text block and whether the valid text block is located immediately to the right side of the icon, according to coordinate information of the valid text blocks and the icons;
if yes, combining the icon and the valid text block as a legend of the graph.

8. The method according to claim 5, wherein the chart area contains the graphic object of which the type is a sector object, the method further comprising:
determining whether a valid text block indicating information on the proportion of the sector object is present inside or in the vicinity of the sector object;
when the valid text block indicating the information on the proportion of the sector object is present inside or in the vicinity of the sector object, taking the valid text block as the proportion of the sector object;
calculating an angle of the sector and dividing the angle by 360° when the valid text block indicating the information on the proportion of the sector object is not present inside or in the vicinity of the sector object, and taking the result as the proportion of the sector object.

9. The method according to claim 5, further comprising:
a) dividing the chart area into an upper subarea and a lower subarea in an up-down direction, and dividing the chart area into a left subarea and a right subarea in a left-right direction;
b) randomly selecting a subarea from the upper subarea, the lower subarea, the left subarea and the right subarea, determining whether the valid text block in the chart area is spatially intersected with the selected current subarea;
c) if yes, determining that the valid text block belongs to the current subarea;
d) determining whether the number of the valid text blocks in the current subarea is greater than or equal to two;
e) if the number of valid text blocks in the current subarea is greater than or equal to two, screening out a scale contained in the current subarea from the valid text blocks;
repeating steps b) to e) until the upper subarea, the lower subarea, the left subarea and the right subarea are completely traversed.

10. The method according to claim 9, wherein the step of screening out the scale contained in the current subarea from the valid text blocks specifically comprises:
screening out, from the valid text blocks in the left subarea, a valid text block of which a right edge is substantially aligned in a vertical direction and equally spaced in the vertical direction, to take the valid text block as a scale of the left subarea, if the current subarea is the left subarea;
screening out, from the valid text blocks in the lower subarea, a valid text block of which an upper edge is substantially aligned in a horizontal direction and equally spaced in the horizontal direction, to take the valid text block as a scale of the lower subarea, if the current subarea is the lower subarea;
screening out, from the valid text blocks in the right subarea, a valid text block of which a left edge is substantially aligned in the vertical direction and equally spaced in the vertical direction, to take the valid text block as a scale of the right subarea, if the current subarea is the right subarea;
screening out, from the valid text blocks in the upper subarea, a valid text block of which a lower edge is substantially aligned in the horizontal direction and equally spaced in the horizontal direction, to take the valid text block as a scale of the upper subarea, if the current subarea is the upper subarea.

11. The method according to claim 9, further comprising:
after the upper subarea, the lower subarea, the left subarea and the right subarea are completely traversed:
semantically analyzing the scale contained in each obtained subarea respectively to determine whether the scale may be converted into a time sequence or a numerical sequence;
setting the scale as a time type, and saving a time stamp corresponding to each scale after it is converted into the time sequence, if the scale can be converted into the time sequence;
setting the scale as a numerical type, and saving a floating point corresponding to each scale after it is converted into the numerical type, if the scale can be converted into the numerical sequence; and
setting the scale as a label type if the scale can be converted to neither the time sequence nor the numerical sequence.

12. The method according to claim 11, wherein the scale is the time type or the numerical type, the method further comprising:
counting the number of vertexes of the valid broken line objects in the chart area;
determining whether the number of the vertexes is greater than the number of the scales contained in the lower subarea or the upper subarea and whether the number of the scales contained in the lower subarea or the upper subarea is not less than 2; if yes, making a perpendicular line to an X-axis from the vertex in the vertical direction, obtaining the distances between a foot of the perpendicular line and two adjacent scales, and in combination with the time stamps or the floating points corresponding to the scales, calculating an X-axis coordinate corresponding to the vertex by using a linear difference method;
making a perpendicular line to a Y-axis from the vertex in the horizontal direction, obtaining the distances between the foot of the perpendicular line and two adjacent scales, and in combination with the time stamps or the floating points corresponding to the scales, calculating a Y-axis coordinate corresponding to the vertex by using the linear difference method.

13. The method according to claim 11, wherein the scale is the label type, the method further comprising:
counting the number of the vertexes of the valid broken line objects in the chart area;
determining whether the number of the vertexes is greater than the number of the scales contained in the lower subarea or the upper subarea and whether the number of the scales contained in the lower subarea or the upper subarea is not less than 2; if yes, making the perpendicular line to the X-axis from the vertex in the vertical direction, obtaining the distances between the foot of the perpendicular line and two adjacent scales, taking the scale with a shorter distance from the foot of the perpendicular line as the X-axis coordinate corresponding to the vertex;
making the perpendicular line to the Y-axis from the vertex in the horizontal direction, obtaining the distances between the foot of the perpendicular line and two adjacent scales, taking the scale with a shorter distance from the foot of the perpendicular line as the Y-axis coordinate corresponding to the vertex.

14. The method according to claim 11, wherein the scale is the time type or the numerical type, the method further comprising:
determining whether the columnar object is a columnar object in the vertical direction;
if yes, counting the number of the valid columnar objects in the chart area;
determining whether the number of the columnar objects is greater than the number of the scales contained in the lower subarea or the upper subarea, and whether the number of scales contained in the lower subarea or the upper subarea is not less than 2; if yes, making a perpendicular line to the X-axis from the center point of the columnar object in the vertical direction, obtaining the distances between the foot of the perpendicular line and two adjacent scales, and in combination with the time stamps or the floating points corresponding to the scales, calculating a X-axis coordinate corresponding to the columnar object with the linear difference method;
making a perpendicular line to the Y-axis from the center point of the columnar object in the horizontal direction, obtaining the distances between the foot of the perpendicular line and two adjacent scales, and in combination with the time stamps or the floating points corresponding to the scales, calculating the Y-axis coordinate corresponding to the columnar object with the linear difference method.

15. The method according to claim 11, wherein the scale is the label type, the method further comprising:
determining whether the columnar object is a columnar object in the vertical direction;
if yes, counting the number of the valid columnar objects in the chart area;
determining whether the number of the columnar objects is greater than the number of the scales contained in the lower subarea or the upper subarea, and whether the number of the scales contained in the lower subarea or the upper subarea is not less than 2; if yes, making a perpendicular line to the X-axis from the center point of the columnar object in the vertical direction, obtaining the distances between the foot of the perpendicular line and two adjacent scales, taking the scale with the shorter distance from the foot of the perpendicular line as the X-axis coordinate corresponding to the columnar object;
making a perpendicular line to the Y-axis from the center point of the columnar object in the horizontal direction, obtaining the distances between the foot of the perpendicular line and two adjacent scales, taking the scale with the shorter distance from the foot of the perpendicular line as the Y-axis coordinate corresponding to the columnar object.

16. An electronic device for extracting chart information in a file, comprising:
a processor;
memory; and
a plurality of computer instructions stored in the memory, wherein the computer instructions, when executed by the processor, cause the electronic device to perform operations including:
inputting, by the electronic device, a file which includes a to-be-identified page;
parsing, by the electronic device, an underlying data stored in the to-be-identified page, and combining the underlying data into a data block according to a behavior identifier in the underlying data;
extracting, by the electronic device, a graphic object and a word object from the data block respectively, and obtaining location information of the word object and of the graphic object in the to-be-identified page;
identifying, by the electronic device, a chart area in the to-be-identified page according to the graphic object and the word object; and
performing, by the electronic device, data fusion on the word object and the graphic object in the chart area to obtain the chart information contained in the chart area, wherein the chart information comprising one or more of a title, a legend, a scale, and a scale attribute.

17. The electronic device according to claim 16, wherein the step of identifying the chart area in the to-be-identified page according to the graphic object and the word object comprises:
a) randomly selecting one graphic object from the graphic objects and taking the area thereof as a candidate chart area;
b) determining whether most of the graphic objects and/or the word objects adjacent to the candidate chart area are located inside the candidate chart area;
c) if yes, combining the graphic objects and/or the word objects adjacent to the candidate chart area with the candidate chart area to obtain a new candidate chart area;
repeating steps b) and c) on the electronic device until most of the graphic objects and/or the word objects adjacent to the newest candidate chart area are located outside the newest candidate chart area, and taking the newest candidate chart area as the chart area of the to-be-identified page.

18. The electronic device according to claim 16, wherein the step of extracting the graphic object and the word object respectively from the data block specifically comprises:
extracting filled elements and/or contour elements from the graphic object, and parsing out colors and paths of the filled elements and/or the contour elements;
determining the type of the graphic object according to the colors and the paths of the filled elements and/or the contour elements; the type of the graphic object comprising at least one of a sector object, a broken line object, an area object, a columnar object, a coordinate axis, a coordinate axis scale line, an auxiliary line, an icon, and a bitmap object, and when the graphic object contains a bitmap object, identifying the word object contained in the bitmap object by using an OCR model; and
reconstructing semantically related word objects in close proximity into a valid text block according to location information of the word object and semantic information of the word object; wherein the semantic information comprising one or more of a character type, a font type, a font size, a font color, and a font direction.

19. A non-transitory computer readable storage medium comprising computer readable instructions that, when executed by a processor of an electronic device, cause the electronic device to perform operations including:
inputting, by the electronic device, a file which includes a to-be-identified page;
parsing, by the electronic device, an underlying data stored in the to-be-identified page, and combining the underlying data into a data block according to a behavior identifier in the underlying data;
extracting, by the electronic device, a graphic object and a word object from the data block respectively, and obtaining location information of the word object and of the graphic object in the to-be-identified page;
identifying, by the electronic device, a chart area in the to-be-identified page according to the graphic object and the word object; and
performing, by the electronic device, data fusion on the word object and the graphic object in the chart area to obtain the chart information contained in the chart area, wherein the chart information comprising one or more of a title, a legend, a scale, and a scale attribute.

20. The non-transitory computer readable storage medium according to claim 19, wherein the step of identifying the chart area in the to-be-identified page according to the graphic object and the word object comprises:
a) randomly selecting one graphic object from the graphic objects and taking the area thereof as a candidate chart area;
b) determining whether most of the graphic objects and/or the word objects adjacent to the candidate chart area are located inside the candidate chart area;
c) if yes, combining the graphic objects and/or the word objects adjacent to the candidate chart area with the candidate chart area to obtain a new candidate chart area;
repeating steps b) and c) on the electronic device until most of the graphic objects and/or the word objects adjacent to the newest candidate chart area are located outside the newest candidate chart area, and taking the newest candidate chart area as the chart area of the to-be-identified page.
